(19) United States
(12) Patent Application Publication
(10) Pub. No.: US 2006/0065188 A1
(43) Pub. Date: Mar. 30, 2006

(54) Method and system for coating a human body

(76) Inventor: Percy Ivan Whitmore, Phoenix, AZ (US)

Correspondence Address: Percy Ivan Whitmore, 4638 East Mountain Vista Drive, Phoenix, AZ, 85048, US

(21) Appl. No.: 10/950,555

(22) Filed: Sep. 28, 2004

(51) Int. Cl. B41K 1/00

(52) U.S. Cl. 118/31.5; 424/59

(57) ABSTRACT

A coating system for automatically coating a human body in a coating chamber, followed by automatically cleaning the coating chamber and a method of operating thereof is described. The coating system comprises a coating solution reservoir configured to hold a coating solution, a cleaning solution reservoir configured to hold a cleaning solution; a fluid dispensing device configured to dispense the coating solution or the cleaning solution within the coating chamber; a pumping system coupled to the cleaning solution reservoir and the coating solution reservoir, and configured to supply the cleaning solution from the cleaning solution reservoir or coating solution from the coating solution reservoir to the fluid dispensing device; and a power source coupled to the pumping system, and configured to provide the pumping system with power for pumping the cleaning solution or coating solution. Additionally, the coating system further comprises a control system for controlling the coating system.

### CROSS-REFERENCE TO RELATED APPLICATIONS

This application is related to pending U.S. patent application Ser. No. 10/769,119, entitled “Method and System for Cleaning a Shower”, filed on Jan. 30, 2004. The entire content of this application is herein incorporated by reference in its entirety.

### BACKGROUND OF THE INVENTION

1. Field of the Invention

The present invention relates to a method and system for coating a human body with a coating solution in a coating chamber and, more particularly, to a method and system for coating a human body in a coating chamber followed by automatically cleaning the shower.

2. Description of Related Art

In most dwellings, such as residential homes, hotel lodgings, sports facilities, or hospitals, facilities are provided for cleansing the human body. Such facilities often include a shower stall or sauna, for example, which comprises either a fully closed enclosure, or partially closed enclosure, and a source of hot and cold water for attending to personal hygiene. Due to the nature of the process, the damp environment generally promotes the formation of fungus, such as mildew, etc., as well as the formation of water deposits and both cleanser and body residue within the shower stall. As a result, shower stalls, ubiquitous to human life, require periodic cleaning, which is typically an extremely time-consuming and strenuous procedure involving significant mechanical energy exerted by the human user.

Additionally, the shower stall can permit the application of various fluids to all or selected parts of the human body. Such fluids can include self-tanning formulations, sunscreens, suntan lotions, tanning accelerators, sunburn treatments, insect repellants, skin toners, skin bleaches, skin lighteners, anti-microbial compositions, moisturizers, exfoliants, nutriments or vitamins, massage aides, muscle relaxants, skin treatment agents, burn treatment agents, decontamination agents, cosmetics, wrinkle treatments or removers. However, the application of such fluids in the shower stall can lead to further accumulation of residue.

### SUMMARY OF THE INVENTION

One aspect of the present invention is to reduce or eliminate any or all of the above-described problems.

Another object of the present invention is to provide a system and method for automatically cleaning a coating chamber following the dispensing of a coating solution on a human body.

According to another aspect, a coating system is described comprising: a coating chamber configured to receive a human body; a coating solution reservoir configured to hold a coating solution; a cleaning solution reservoir configured to hold a cleaning solution; a fluid dispensing device configured to automatically dispense the coating solution within the coating chamber on the human body, and automatically dispense the cleaning solution within the coating chamber; a pumping system coupled to the cleaning solution reservoir and configured to supply the cleaning solution from the cleaning solution reservoir to the fluid dispensing device, and coupled to the coating solution reservoir and configured to supply coating solution from the coating solution reservoir to the fluid dispensing device; and a power source coupled to the pumping system, and configured to provide the pumping system with power.

According to another aspect, a method of coating a human body in a coating chamber is described. The method comprises providing a human skin coating composition, introducing the human skin coating composition to the coating chamber; directing the human skin coating composition onto at least a portion of the human body; removing the human body from the coating chamber, and cleaning the coating chamber in order to remove the human skin coating composition from the coating chamber.

According to yet another aspect, a method of coating a human body in a coating system is described. The method comprises: initiating a coating process for coating the human body with a coating solution in a coating chamber configured to receive the human body using a coating system, wherein the coating system comprises a coating solution reservoir configured to store the coating solution, a fluid dispensing device configured for dispensing the coating solution in the coating chamber, and a pumping system coupled to the coating solution reservoir and configured to supply the coating solution from the coating solution reservoir to the fluid dispensing device; dispensing the coating solution on at least a portion of the human body in the coating chamber; terminating the coating process; initiating a cleaning process configured to be performed by the coating system, the coating system further comprises a cleaning solution reservoir configured to store a cleaning solution, wherein the pumping system is further coupled to the cleaning solution reservoir and configured to supply the cleaning solution to the fluid dispensing device; dispensing the cleaning solution in the coating chamber to remove the coating solution from the coating chamber; and terminating the cleaning process.

### BRIEF DESCRIPTION OF THE DRAWINGS

In the accompanying drawings:

FIG. 1 presents a simplified schematic representation of a coating system for coating a human body according to an embodiment of the invention;

FIG. 2A presents a front view of a coating system for coating a human body according to another embodiment of the invention;

FIG. 2B presents a plan view of the coating system depicted in FIG. 2A;

FIG. 3 presents an enclosure for a coating system according to an embodiment of the invention;

FIG. 4 shows an electromechanical schematic for a coating system according to an embodiment of the invention;

FIG. 5 shows an exemplary cross-sectional view of a cap assembly for a cleaning solution reservoir;

FIG. 6 shows a coating system for coating a human body according to another embodiment of the invention;

FIG. 7 shows a frontal view of a fluid dispensing device according to an embodiment of the invention;

FIG. 8 shows a front interior view of a spray column arm according to an embodiment of the invention;

FIG. 9A shows a bushing assembly for mounting a spray column arm;

FIG. 9B shows an assembled bushing assembly as depicted in FIG. 9A;

FIG. 10 shows a hinge assembly for mounting a spray column arm;

FIG. 11 shows an assembly view of the spray column arm depicted in FIG. 8;

FIG. 12A shows an assembly view of an exemplary rotational coupling assembly for a spray column arm and a multi-directional spray column;

FIG. 12B shows an assembly view of an exemplary rotary for a rotational coupling assembly;

FIG. 13 shows a rear interior view of the spray column arm depicted in FIG. 8;

FIG. 14 illustrates a multi-directional spray column according to an embodiment of the invention;

FIG. 15 presents a cross-sectional view of a multi-directional spray column according to an embodiment of the invention;

FIG. 16A presents a screen filter according to an embodiment of the invention;

FIG. 16B shows a screen for the screen filter depicted in FIG. 16A;

FIG. 17 presents a schematic illustration of an electrical layout according to an embodiment of the invention;

FIG. 18 presents another front interior view of the spray column arm depicted in FIG. 8;

FIG. 19 shows a spray column encoder according to an embodiment of the invention;

FIG. 20 shows an arm position encoder according to an embodiment of the invention;

FIG. 21 presents a local control interface for a coating system according to an embodiment of the invention;

FIG. 22 presents a remote control interface for a coating system according to an embodiment of the invention;

FIGS. 23A and 23B show a coating system for coating a human body according to another embodiment of the invention;

FIG. 24 shows a coating system for coating a human body according to another embodiment of the invention;

FIG. 25 shows a coating system for coating a human body according to yet another embodiment of the invention; and

FIG. 26 presents a method of operating a coating system for coating a human body according to an embodiment of the invention.

### DETAILED DESCRIPTION OF EXEMPLARY EMBODIMENTS

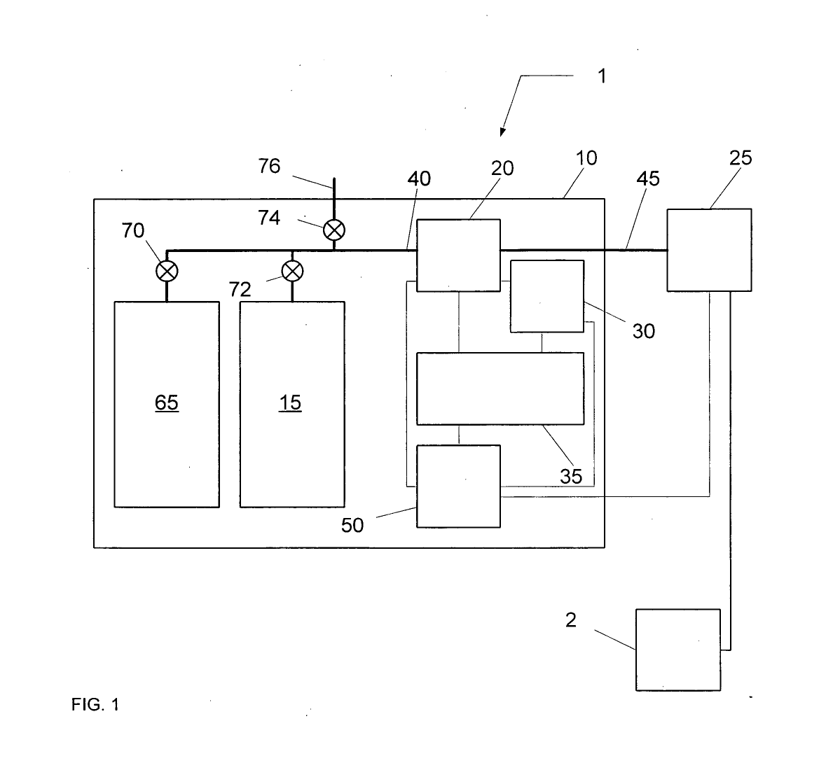

Referring now to the drawings, wherein like reference numerals designate identical or corresponding parts throughout the several views, FIG. 1 presents a coating system 1 configured to dispense a coating solution on a human body in a coating chamber 2, and a cleaning solution in the coating chamber 2. The coating chamber 2 can, for example, include a shower. The cleaning system 1 comprises a cleaning solution reservoir 15 configured to hold the cleaning solution, a coating solution reservoir 65 configured to hold the coating solution, a fluid dispensing device 25 configured to dispense the coating solution on a human body in the coating chamber 2 and to dispense the cleaning solution within the coating chamber 2 for the purpose of cleaning the coating chamber 2, a pumping system 20 coupled to the coating solution reservoir 65 and the cleaning solution reservoir 15, and configured to supply the fluid dispensing device 25 with coating solution and cleaning solution under pressure from the coating solution reservoir 65 and the cleaning solution reservoir 15, respectively. The coating system 1 further comprises a power source 30 coupled to the pumping system 20, and configured to provide the pumping system 20 with power for pumping the coating solution and the cleaning solution. The fluid dispensing device 25 can be stationary, or it can be non-stationary.

Additionally, as shown in FIG. 1, the coating system 1 further comprises a coating solution valve 70 configured to open and close access to the coating solution reservoir (i.e., when the coating solution valve is open, the coating solution can be supplied to the coating chamber, and when the coating solution valve is closed, the coating solution can not be supplied to the coating chamber), and a cleaning solution valve 72 configured to open and close access to the cleaning solution reservoir (i.e., when the cleaning solution valve is open, the cleaning solution can be supplied to the coating chamber, and when the cleaning solution valve is closed, the cleaning solution can not be supplied to the coating chamber). Furthermore, the coating system 1 can comprise a purge valve 74 and purge line 76 configured to purge the pumping system 20 and the fluid dispensing device 25. The purge line 76 can, for example, be configured to supply water to the coating system.

The coating solution can include a self-tanning composition, a muscle relaxant composition, a sunburn treatment composition, an insect repellant composition, a skin toner composition, an exfoliant composition, an anti-microbial composition, a skin nutriment composition, a skin vitamin composition, a skin wrinkle treatment composition, a skin decontamination composition, a medicated skin treatment composition, a moisturizing composition, fragrant composition, a cosmetic composition, or a massaging aid composition, or any combination thereof.

The cleaning solution can comprise at least one of a cleaning solvent, water, or any combination thereof.

For example, the inlet of pumping system 20 can be coupled to the cleaning solution reservoir 15 and the coating solution reservoir 65 via a first fluid supply line 40, and the outlet of pumping system 20 can be coupled to the fluid dispensing device 25 via a second fluid supply line 45. The pumping system 20 can include at least one of an impeller, an electric motor, and a gear box. Alternately, the pumping system 20 can include a high pressure fluid supply line such as a water line, a control valve coupled to the high pressure fluid supply line, and a diaphragm, wherein the diaphragm is coupled to the cleaning solution reservoir 15 (or coating solution reservoir 65). When the control valve is opened, the diaphragm is pressurized causing the expulsion of cleaning solution (or coating solution) from the cleaning solution reservoir 15 (or coating solution reservoir). When the control valve is closed, the diaphragm is depressurized causing the expulsion of cleaning solution (or coating solution) from the cleaning solution reservoir 15 (or coating solution reservoir 65) to terminate.

Additionally, the cleaning system 1 can further comprise a control system 35 coupled to at least one of the pumping system 20 and the fluid dispensing device 25, and configured to operate at least one of the pumping system 20 and the fluid dispensing device 25 according to a coating recipe or a cleaning recipe. For example, the cleaning recipe can set at least one of a target pressure, a target position of the fluid dispensing device, a target rate of translation of the fluid dispensing device, and a target rate of rotation of the fluid dispensing device. Additionally, for example, the control system is configured to perform at least one of minimizing a difference between the target pressure and a measured pressure, minimizing a difference between the target position for the fluid dispensing device and a measured position, minimizing a difference between the target rate of translation of the fluid dispensing device and a measured rate of translation, and minimizing a difference between the target rate of rotation of the fluid dispensing device and a measured rate of rotation. Additionally, for example, the cleaning recipe can be configured for a size of the coating chamber. Furthermore, for example, the coating recipe can set at least one of a target pressure, a target position of the fluid dispensing device, a target rate of translation of the fluid dispensing device, and a target rate of rotation of the fluid dispensing device. Additionally, for example, the control system is configured to perform at least one of minimizing a difference between the target pressure and a measured pressure, minimizing a difference between the target position for the fluid dispensing device and a measured position, minimizing a difference between the target rate of translation of the fluid dispensing device and a measured rate of translation, and minimizing a difference between the target rate of rotation of the fluid dispensing device and a measured rate of rotation. Additionally, for example, the coating recipe can be configured for a size of the coating chamber.

Additionally, the coating system 1 can further comprise an enclosure 10 configured to enclose at least one of the cleaning solution reservoir 15, the coating solution reservoir 65, the pumping system 20, the fluid dispensing device 25, the power source 30, and the control system 35. For example, the enclosure can comprise a sealable enclosure sufficient to prevent penetration of coating solution, cleaning solution, rinsing solution, or shower water therein. Moreover, the enclosure 10 can be configured to mount the coating system 1 on a wall of the coating chamber 2. As depicted in FIG. 1, the enclosure 10 provides an enclosure for the cleaning solution reservoir 15, the coating solution reservoir 65, the pumping system 20, the power source 30, and the control system 35.

In an alternate embodiment, referring still to FIG. 1, the coating system 1 can further comprise a detection system 50 for performing at least one of: determining whether a person, or other object, is within the coating chamber 2; determining whether or not the door is open or closed; determining whether a control component has failed; determining a status of the fluid dispensing device 25; determining a status of the pumping system 20; determining a status of the power source 30; etc., and providing control data to control system 35 for controlling coating system 1. For example, the detection system 50 can comprise at least one of an optical detector, a motion detector, an infrared (IR) sensor, a door switch, a magnetic reed switch, an optical switch and encoder, etc.

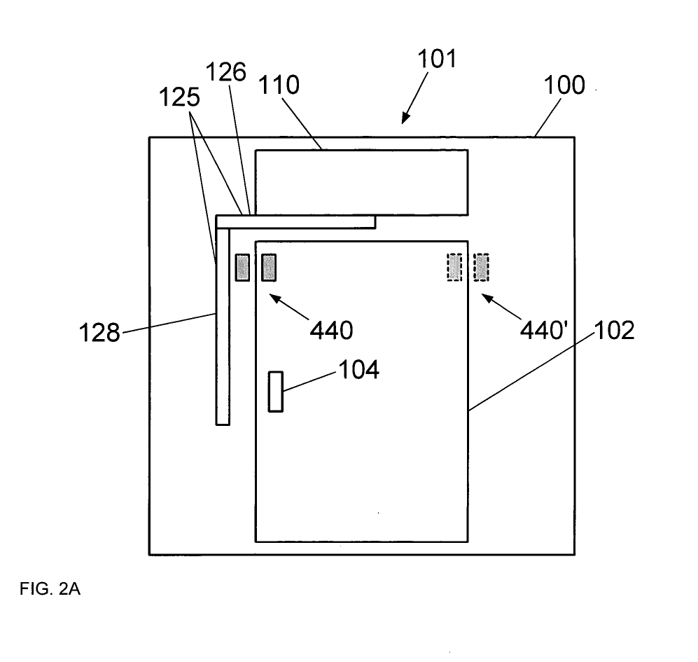

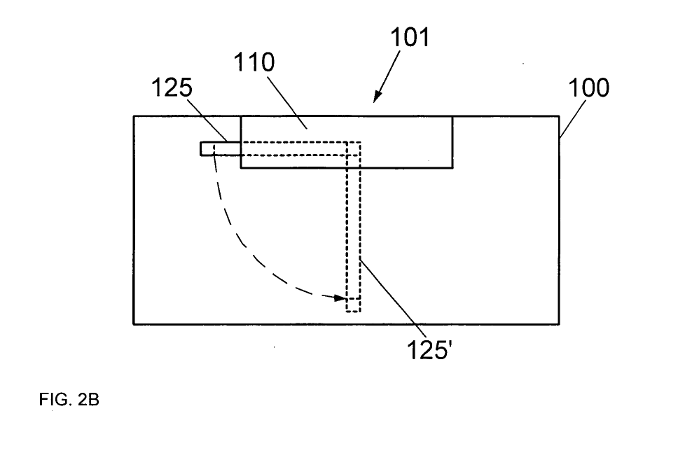

Now referring to FIG. 2A, a front view of an exemplary coating chamber 100 having a coating system 101 mounted therein is illustrated. The coating chamber 100 can include a fully-enclosed shower stall (as shown) with at least one water dispensing system (e.g., shower faucet), or alternatively it may include a partially-closed shower stall such as a bottom enclosure (e.g., bath tub), a three wall enclosure, and a shower curtain with at least one water dispensing system. For instance, as illustrated in FIG. 2A, the coating chamber 100 includes a fully-enclosed shower stall having a door 102 with a door handle 104.

The coating system 101 comprises an enclosure 110 configured to be mounted on a wall within, or proximate to, the coating chamber 100, and configured to enclose the cleaning solution reservoir (not shown), the coating solution reservoir (not shown), the pumping system (not shown), the power source (not shown), and the control system (not shown). Additionally, the cleaning system comprises a fluid dispensing device 125 coupled to enclosure 110, wherein the fluid dispensing device 125 includes a spray column arm 126 coupled to an outlet of the pumping system via tubing in enclosure 110, and a multi-directional spray column 128 coupled to the spray column arm 126.

The spray column arm 126 can be configured to perform at least one of translating or rotating the multi-directional spray column 128 within coating chamber 100. For example, FIG. 2B presents a top view of coating chamber 100, wherein the fluid dispensing device 125 is shown to be in an OFF position, and the fluid dispensing device 125′ is shown to be in an ON position. In the ON position, the spray column arm 126 has been rotated 90 degrees about a vertical axis extending through a pivot point coupling the spray column arm 126 to at least one of the coating chamber wall and the enclosure 110. Thereafter, the multi-directional spray column 128 may be rotated about a vertical axis extending through a pivot point coupling the multi-directional spray column 128 to the spray column arm 126. Additionally, the multi-directional spray column arm 128 may be translated vertically (i.e., parallel to the orientation of the multi-directional spray column 128), or laterally (i.e., perpendicular to the orientation of the multi-directional spray column 128).

The spray column arm 126 can, for example, be located below the enclosure 110. The electrical and mechanical devices that enable its movement, such as translation and rotation of the multi-directional spray column 128 can be located inside the body of each arm. The multi-directional spray column 128 is coupled to the spray column arm 126.

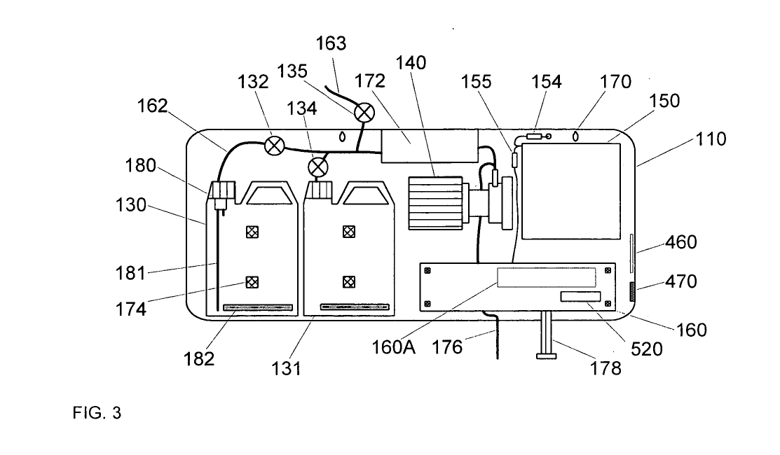

The enclosure 110 can, for example, include a 16.0″ (length)×10.0″ (height)×2.3″ (depth) rectangular box comprising two ABS plastic pieces, a front cover and chassis. As illustrated in FIG. 3, a layout of the interior of enclosure 110 is presented, wherein the chassis houses the cleaning solution reservoir 130, the coating solution reservoir 131, pumping system 140, power source 150, and control system 160. For example, control system 160 can comprise one or more printed circuit boards and other electrical components.

Enclosure 110 can be configured to mount to a wall, (as shown in FIG. 2A) above the shower spray, onto a back-plate (not shown). The back-plate attaches to the shower wall with anchor bolts, or super adhesive tape, or both. The back-plate enables chassis removal from the wall without disturbing the coupling of the coating system to the wall. Back-plate screw slots 170 (see FIG. 3) inside the enclosure 110 are the back-plate attachment points to the enclosure 110. Additionally, the enclosure 110 can comprise a tubing restraint 172 in order to hold tubing 162, which couples cleaning solution reservoir 130 through first valve 132, coating solution reservoir 131 through second valve 133, and water purge line 163 through third valve 134 to pumping system 140, in place and allow for removal of the cleaning solution reservoir 130 and the coating solution reservoir 131 from enclosure 110. To prevent the cleaning solution reservoir 130 from inadvertently falling out of the enclosure 110 when the front cover has been removed, it can be attached to the enclosure chassis with fasteners 174, such as Velcro tabs. The coating solution reservoir 131 can, for example, also be attached in the same manner. Slots on the bottom of the chassis allow enclosure tubing 176 (from the outlet of pumping system 140) and enclosure electrical cable 178 (such as an electrical ribbon cable) to exit for fluid and electrical coupling, respectively, to the spray column arm 126. The front cover fits over the chassis and protects the components from the shower area environment. It also can display a local control interface (to be discussed below), that may include a control panel, a cleaning solution level window, and a coating solution level window. The control panel, display, and text can be printed onto the cover via, for instance, silk-screening. In order to keep the front cover in place, tabs placed on four sides of the front cover can fit into corresponding slots on the chassis.

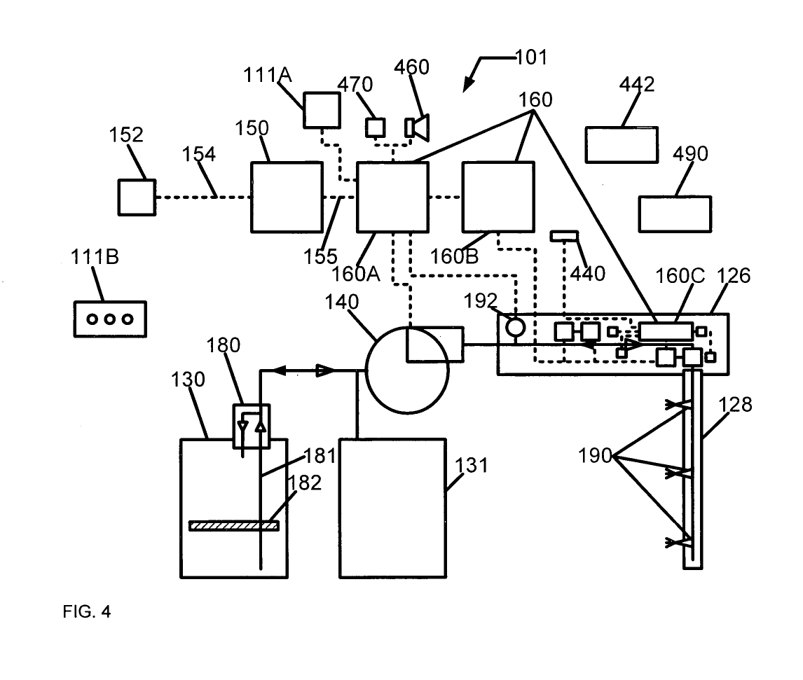

FIG. 4 presents a high level schematic of the electromechanical layout of the coating system 101. Arrows on the tubing lines indicate cleaning solution flow. Forward flow is represented by open arrows pointing to the suction side of pumping system 140, and away from the pressure side of pumping system 140. Solid arrows pointing in the opposite direction to that of the forward (open) flow arrows represent the reverse flow. When power (or polarity) to the pumping system 140 is reversed, any cleaning solution remaining within the tubing flows in reverse, returning to the cleaning solution reservoir 130. The cap assembly 180 allows for the cleaning solution to exit from the bottom through a valve stem 181, and enter through the top of the cleaning solution reservoir 130. The cap assembly 180 design prevents cleaning solution agitation (which results in a large volume of suds) when pumped back into the cleaning solution reservoir 130. It also may have a vent that allows the cleaning solution reservoir 130 pressure to remain balanced.

Referring still to FIG. 4, the cleaning solution reservoir 130 can, for example, comprise a 32 oz. clear “F” type jug. Additionally, the coating solution reservoir 131 can, for example, comprise a 32 oz. Clear “F” type jug. The level of cleaning solution can, for example, be seen through a level window in the housing front cover. Furthermore, the level of coating solution can, for example, be seen through a level window in the housing front cover. To aid in determining the cleaning solution level, a float 182, such as a foam float, visible from the level window can be located inside the cleaning solution reservoir 130. Moreover, to aid in determining the coating solution level, a float, such as a foam float, visible from the level window can be located inside the coating solution reservoir 130. The pumping system 140 pressurizes the cleaning solution (or coating solution) inside the tubing distribution system. A single tube 162 carries the pressurized liquid from the cleaning solution reservoir 130 (or coating solution reservoir 131) to the pumping system 140 and on to the multi-directional spray column 128 through tubing 176 where it manifolds to one or more spray nozzles 190. For example, the tubing 162 and 176 can include quarter inch outer DIA polyurethane tubing rated for 100 Psi. Spray nozzles 190 may comprise at least one of an orifice, or a slot. Alternatively, each spray nozzle 190 has at least one of a circular cross-section, an ovular cross-section, a rectangular cross-section, or an annular cross-section.

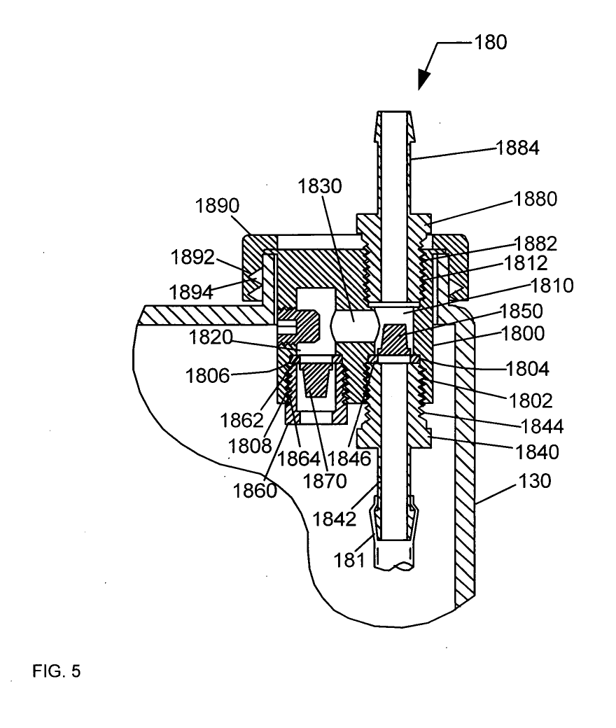

For example, now referring to FIG. 5, a cross-sectional view of cap assembly 180 is presented. Cap assembly 180 can include a cap body 1800 having a first passage 1810, a second passage 1820, and a coupling passage 1830 configured to couple the first passage 1810 and the second passage 1820. Valve stem 181 is coupled to the first passage 1810 of cap body 1800 via first connector 1840. Valve stem 181 can, for example, include a semi-rigid polypropylene tube having an inner diameter of ⅛ inch and an outer diameter of ¼ inch. Valve stem 181 can, for example, be press-fit over a tubular end 1842 of first connector 1840. First connector 1840 can, for example, include a threaded end 1844 configured to couple with a first tapped hole 1802 in cap body 1800. First connector 1840 can further be configured to capture a first duckbill 1850 between a first end surface 1846 of first connector 1840 and a first retaining lip 1804 in cap body 1800. A second connector 1860 is utilized to capture a second duckbill 1870 between a second end surface 1862 of the second connector 1860 and a second retaining lip 1806 in cap body 1800. Second connector 1860 can, for example, include a threaded end 1864 configured to couple with a first tapped hole 1808 in cap body 1800. A third connector 1880 is utilized to couple the first passage 1810 in cap body 1800 to tubing 162. Third connector 1880 can, for example, include a threaded end 1882 configured to couple with a third tapped hole 1812 in cap body 1800. Tubing 162 can, for example, be press-fit over a tubular end 1884 of third connector 1880. Additionally, cap body 1800 can be coupled to the cleaning solution reservoir 130 using a retaining ring 1890 having a tapped inner surface 1892 configured to couple with a threaded surface 1894 on the cleaning solution reservoir 130.

As shown in FIG. 5, the orientation of the first duckbill 1850 and the second duckbill 1870 are such that, when pumping system 140 causes a forward flow (see FIG. 4), the first duckbill 1850 is open and the second duckbill 1870 is closed, hence, permitting a flow of cleaning solution from the valve stem 181, through the first passage 1810 and to the tubing 162. As shown in FIG. 5, the orientation of the first duckbill 1850 and the second duckbill 1870 are such that, when pumping system 140 causes a reverse flow (see FIG. 4), the first duckbill 1850 is closed and the second duckbill 1870 is open, hence, permitting a flow of cleaning solution from the tubing 162, through the first passage 1810, through the coupling passage 1830, through the second passage 1820, and to the top of the cleaning solution reservoir 130. The first duckbill 1850 and the second duckbill 1870 can, for example, be fabricated of rubber, such as model no. VL1300-503-A VA4838 design mold VL1001M11 silicone rubber duckbills commercially available from Vernay Laboratories, Inc. (120 E. South College St., Yellow Springs, Ohio 45387).

The pumping system 140 can, for example, include at least one of an impeller, an electric motor, and a gear box. For example, the pumping system 140 can include a (model no. PQ-12) 12 Volt (DC, Direct Current), 2.2 Amp (Amperage), 20 Psi (Pounds per square inch) miniature gear pump, commercially available from the Greylor Company (Cape Coral, Fla. 33909).

The power source 150 can, for example, include a 12 Volt rechargeable gel cell battery pack. The battery pack can be located on the right hand side of enclosure 110 on a support platform as shown in FIG. 3, above the control system 160 (PCB card). Fasteners, such as Velcro strips, can be used to secure the battery pack to the rear wall of the enclosure chassis. Additionally, for example, a battery charger 152 (for the rechargeable battery pack) can be a UL approved, 800 mA, floating charger, model no. PSC12800A commercially available from Power-Sonic Corporation (9163 Siempre Viva Road, Suites A-F, San Diego, Calif. 92154). In order to recharge the battery pack, it can be removed from the enclosure 110, and coupled to the battery charger 152. The electrical connectors can be orientated so that electrical contact is achieved only when then the polarity of the electrical connections are correct. In order to conserve battery power, the cleaning system 101 can be configured to utilize no power (zero quiescent current) until the start button is depressed.

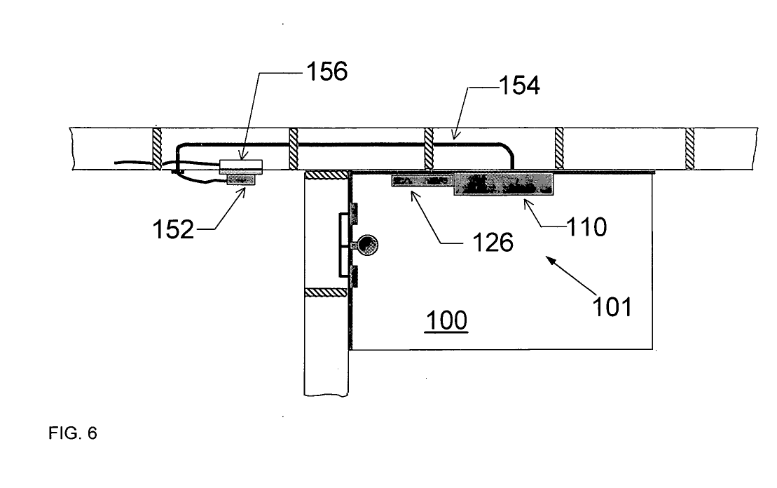

In an alternate embodiment, an optional home power connection kit can be used to continuously charge the power source 150 (or battery pack) while inside the enclosure 110. As illustrated in FIG. 6, the optional home power connection kit includes a “Y” power cable that interconnects the power source 150 (or battery pack) with a battery charger cable 154 coupled to battery charger 152, and a power distribution cable 155 coupled to control system 160 (or power distribution PCB). The battery charger cable 154 is routed from the battery charger 152 to one of the “Y” power cable connectors located inside enclosure 110. The battery charger 152 may be plugged into an electrical receptacle 156, such as a local, fault interrupting (GFI) 115 V (AC, Alternating Current) electrical receptacle. Battery charger cable 154 from the battery charger 152 to the power source 150 (battery pack) can be routed behind the wall and shower 100 through a wall conduit into enclosure 110.

A pressure measurement device 192 measures the pressure of the cleaning solution (or coating solution) inside the tubing. For example, the pressure measurement device can comprise a pressure transducer, such as model no. MPX5700GP-ND (0 to 101.5 Psi, gauge), commercially from Digikey. The pressure measurement device 192 may be located anywhere within the plumbing (tubing) downstream of the pressure side of pumping system 140. When the pressure reaches a predetermined level, the multi-directional spray column 128 is allowed to rotate, signaling the beginning of the cleaning process. If the pressure fails to reach the predetermined level within a predetermined time duration, the dispensing system can return to the stow position, and the coating system 101 resets. Since the pressure failed to reach the predetermined value, it is assumed, for instance, that the cleaning solution reservoir 130 is empty, the coating solution reservoir 131 is empty, or the pumping system 140 has cavitated.

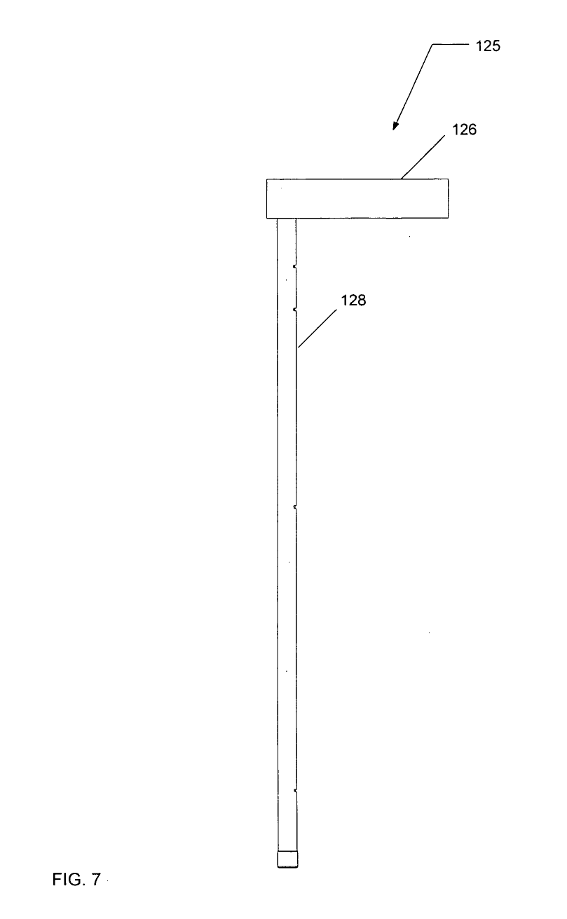

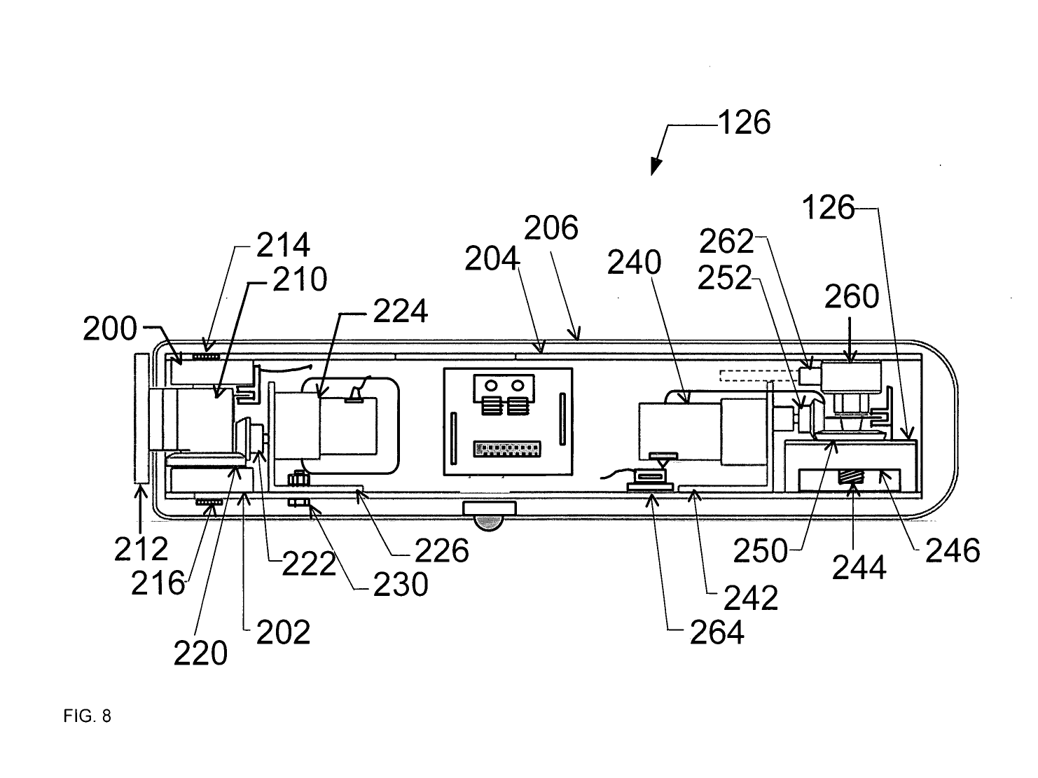

As described above, the fluid dispensing device 125 comprises spray column arm 126 and multi-directional spray column 128 as shown in FIG. 7. The spray column arm 126 supports and positions the multi-directional spray column 128 for shower cleaning solution distribution and coating solution distribution. For example, an aluminum channel and plate are hinged together to create the structural support. FIG. 8 represents an inside layout of the spray column arm 126.

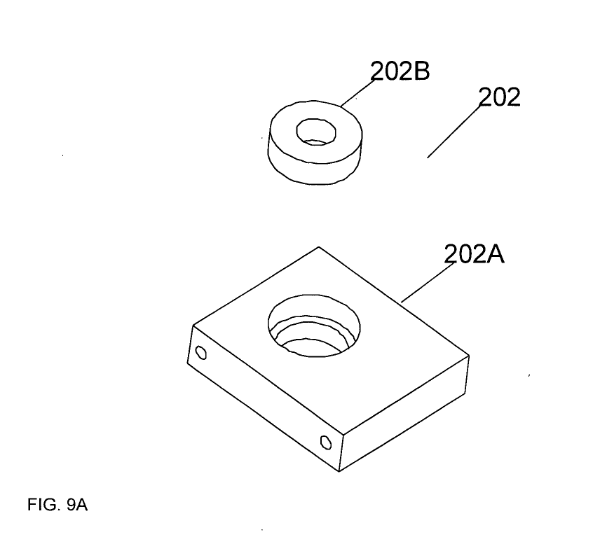

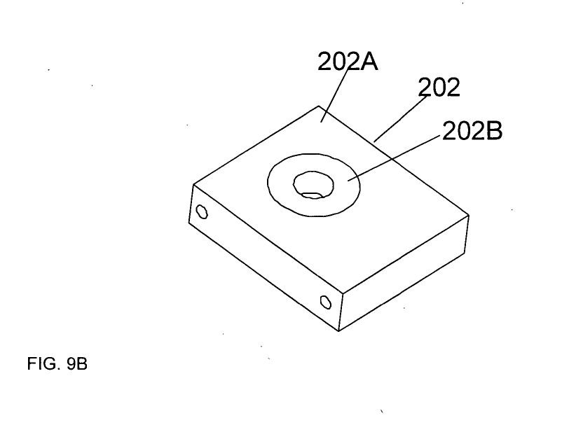

As shown in FIG. 8, top and bottom blocks, 200 and 202, respectively, contain bearings, which allow the spray column arm 126 to move freely about its hinge (or pivot) point via an arm mount support 210. FIGS. 9A and 9B present an exploded view and an assembly view, respectively, of an exemplary block 202 having a bushing block 202A and a bearing 202B. Additionally, the top block 200 can be fabricated as shown in FIGS. 9A and 9B.

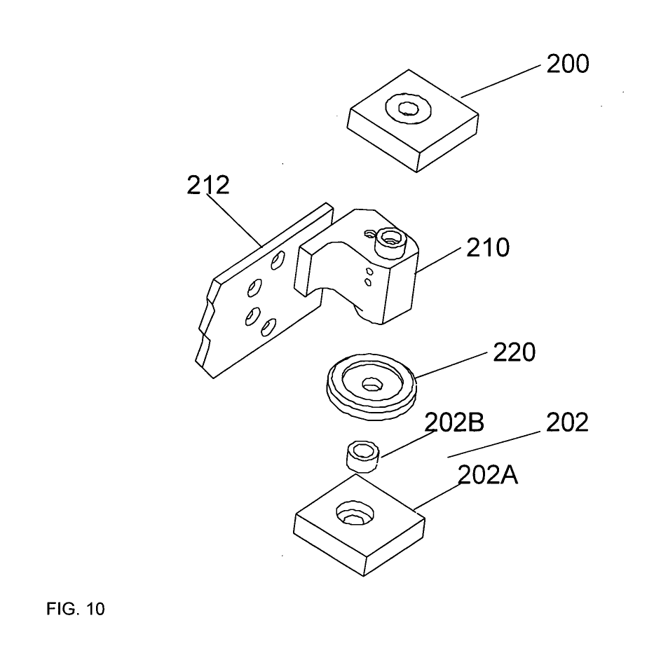

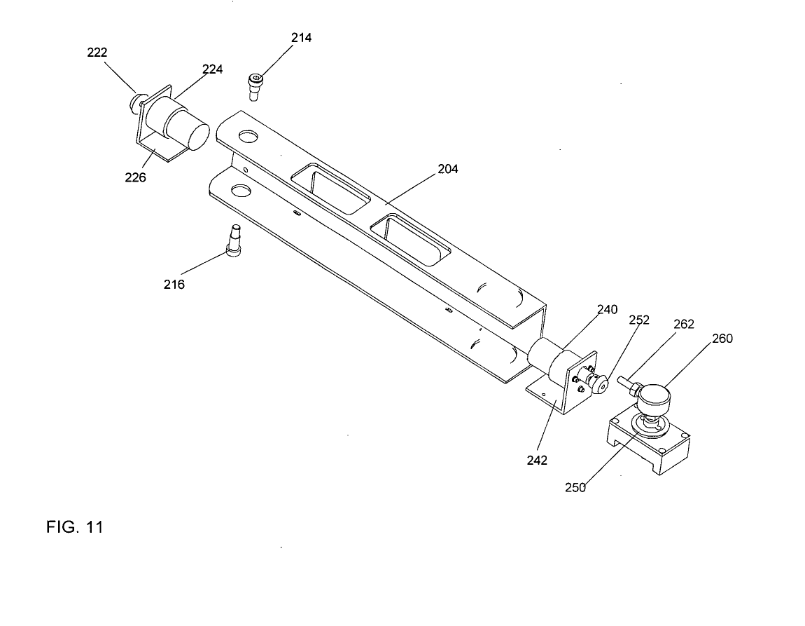

Referring now to FIGS. 8 and 10, the arm mount support 210 is attached to the spray column arm back-plate 212 that is attached to a sub-back-plate (not shown). The sub-back-plate is mounted to the shower wall with anchor bolts, or super adhesive double-sided tape, or both. The sub-back-plate permits easy removal of the spray column arm 126 from the shower wall without disturbing the coupling of the spray column arm 126 to the shower wall. As depicted in FIGS. 8, 10, and 11, a top shoulder bolt 214 and a bottom shoulder bolt 216 extend through the top block 200 and the bottom block 202, respectively, and fasten to the arm mount support 210. These shoulder bolts, 214 and 216, attach the spray column arm back-plate 212 with the arm mount support 210 to the top and bottom blocks, 200 and 202, that are anchored to a frame 204, for example, an aluminum frame, thereby creating the hinge point.

Referring still to FIGS. 8, 10, and 11, attached to the arm mount support 210 is the arm assembly gear 220. An arm motor gear 222 is configured to couple with the arm assembly gear 220. The arm motor gear 222 is coupled to an arm motor 224. An arm motor bracket 226 is coupled to the arm motor 224, and the frame 204. When the arm motor 224 is activated, the arm motor gear 222 moves around the arm assembly gear 220, which is coupled to the arm mount support 210. This action causes the frame 204 to move around the arm mount support 210.

An arm gear tension bolt 230 allows the tension between the arm assembly gear 220 and the arm motor gear 222 to be adjusted so that the spray column arm 126 can be manually closed without damaging either gear. The arm gear tension bolt 230 also determines the force at which the gears can disengage when the spray column arm 126 movement is obstructed. The arm gear tension bolt 230 extends through aligned slots in the arm motor bracket 226 and frame 204, and has a hex-nut on its end. When the nut is tight, the surfaces are compressed, creating tension between the arm assembly gear 220 and the arm motor gear 222. The distance, along the base of the arm motor bracket 226, from the arm gear tension bolt 230 to the front of the arm motor bracket 226 (where the motor is attached) is allowed to move upward, disengaging the arm assembly gear 220 and the arm motor gear 222 when the force becomes sufficiently large. As the arm gear tension bolt 230 moves closer to the arm assembly gear 220 and the arm motor gear 222, the force required to disengage the gear is increased.

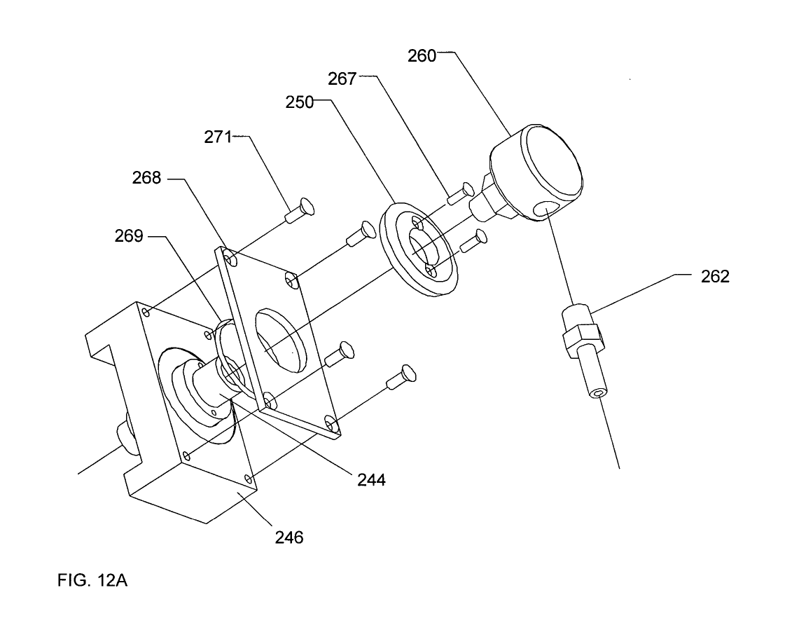

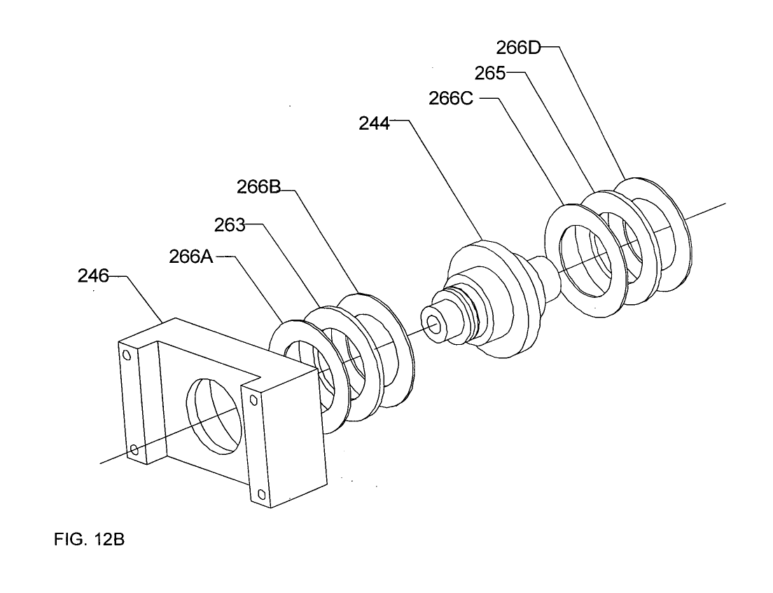

Additionally, as shown in FIGS. 8, 11, and 12A, a spray column motor 240 is utilized to rotate the multi-directional spray column 128, and permit rotating the dispensing of the cleaning solution and coating solution. A spray column motor bracket 242 anchors the spray column motor 240 to the frame 204. The multi-directional spray column 128 couples to the bottom of a rotary 244. The rotary 244 passes through a rotary table 246 and a rotary table plate 268, and couples to a column gear 250. When the spray column motor 240 is actuated, a column motor gear 252 rotates causing the column gear 250 and the attached rotary 244 to rotate. Because the multi-directional spray column 128 is attached to the rotary 244, it also rotates. Fasteners 267, such as bolts, are utilized to couple the column gear 250 to the rotary 244. The rotary 244 is hollow through its center to allow the cleaning solution or coating solution to flow into the multi-directional spray column 128. As depicted in FIG. 12A, the rotary 244 is captured within the rotary table 246 via rotary table plate 268, compliant device 269, and fasteners 271. The compliant device 269 can, for example, include an elastomer O-ring.

As shown in FIGS. 12A and 12B, a first thrust bearing 263, a second thrust bearing 265, a first washer 266A, a second washer 266B, a third washer 266C, and a fourth washer 266D are positioned above and below the top and bottom sides of the rotary 244, inside the rotary table 264. These bearings permit the rotation of the multi-directional spray column 128. A swivel joint 260 attaches to the tube from the pumping system 140 by way of a tubing connector 262, and to the rotary 244. Cleaning solution or coating solution travels in the tube through the swivel joint 260 and rotary 244 into the multi-directional spray column 128. The swivel joint 260 provides a means for the cleaning solution to enter the multi-directional spray column 128 while it rotates. For example, the swivel joint can include a model no. 10010 90 degree swivel joint (with ⅛ NPT thread), commercially available from Rotary Systems, Inc. (1036 McKinley Street, Anoka, Minn. 55303).

Directly behind the column motor bracket 242 is a magnetic arm latch 264. The magnetic arm latch 264 can, for example, retain the spray column arm 126 in the closed position when closed manually. The accompanying latch plate is attached to the back-plate directly across from the latch magnet.

The spray column arm 126 can, for example, have a height of approximately 3.5 inches, and a depth of 2.5 inches. The length can vary, depending on the size of the shower. The electrical and mechanical devices, as depicted in FIG. 8, that enable its movement are located inside the frame 204 in order to prevent direct exposure to the shower environment. In order to further shield the shower column arm components from the shower environment, a front cover 206 is attached to the front of the spray column arm frame 204.

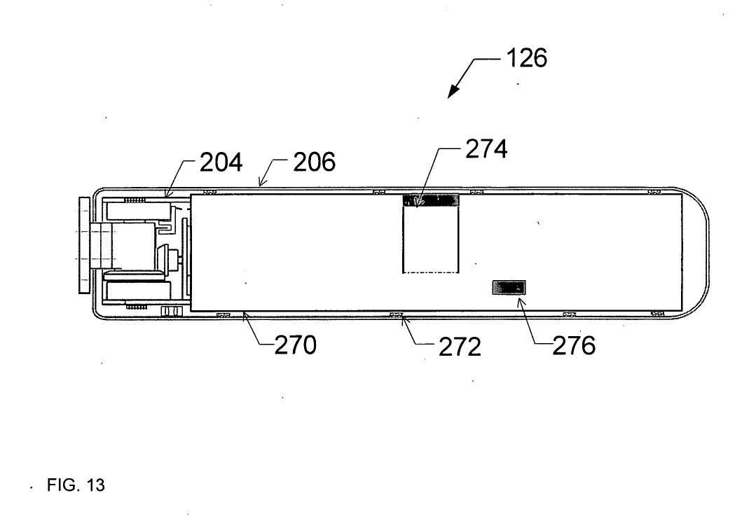

As illustrated in FIG. 13, a back cover 270 also protects the components inside the arm body from the shower environment. It attaches to the inside of the front cover 206 by way of cover fasteners 272, such as Velcro tabs, thereby covering the frame 204. A ball transfer flap 274 provides a ball transfer to pass through the back cover 270 when the spray column arm 126 is in the closed position. An arm magnet latch plate opening 276 allows the magnet inside the spray column arm 126 to mate with a latch plate coupled to the spray column arm back plate 212.

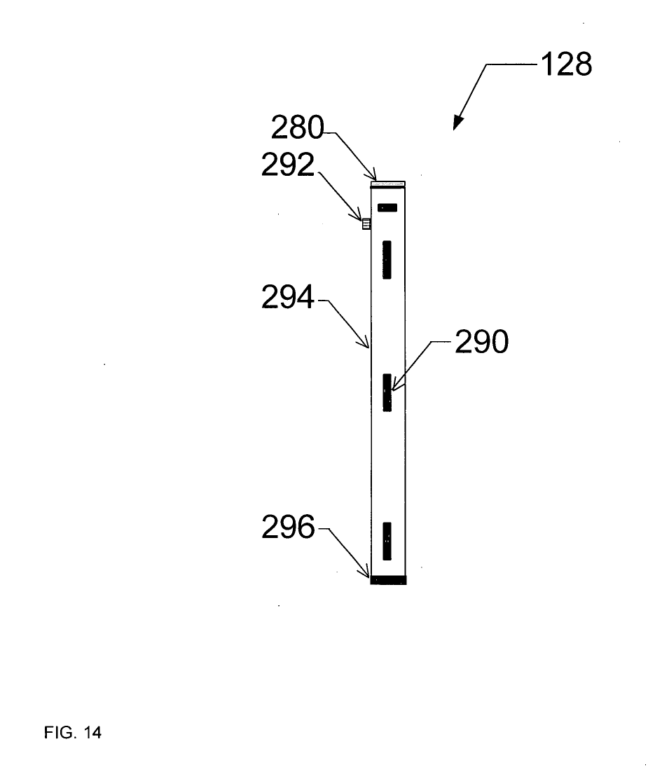

As described above, the multi-directional spray column 128 distributes cleaning solution to the shower surfaces, or coating solution to a human body. In order to do so, the multi-directional spray column 128 rotates with at least one of a constant speed, or a variable speed, while injecting cleaning solution or coating solution, or rinsing solution through one or more spray nozzles 190. FIG. 14 illustrates one embodiment of multi-directional spray column 128. For example, the multi-directional spray column 128 can comprise a cylinder approximately 40 inches in length with a diameter of 1.75 inches.

Referring still to FIG. 14 as well as again to FIG. 8, a tube cap 280 couples into the rotary 244 in such a way that it tightens as it rotates along with it. One or more spray exit slots 290 allow the cleaning solution or coating solution to pass through the multi-directional spray column 128. A top nozzle adjustment knob 292 can be utilized to adjust, for instance, the top nozzle 190 to a desired elevation.

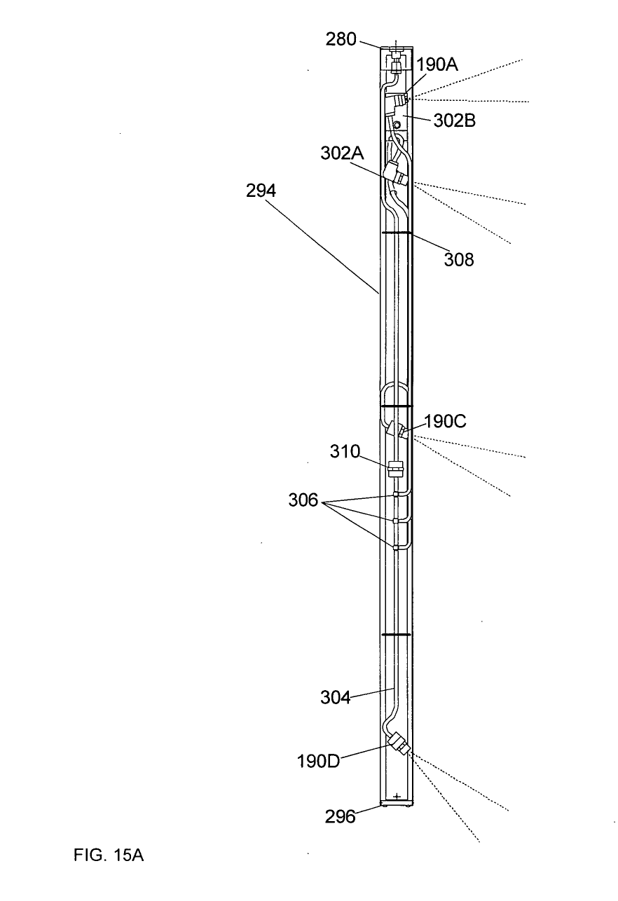

Referring now to FIG. 15A, one embodiment of the spray column nozzle strip layout, located inside a spray column tube 294, is illustrated. A nozzle strip 302A, fabricated, for example, from plastic, is configured to support one or more nozzles 190. As depicted in FIG. 15A, the multi-directional spray column 128 can comprise four (4) spray nozzles 190. Additionally, the nozzle strip 302A can further be configured to support nozzle tubing 304. The four spray nozzles 190 are distributed from the top of the multi-directional spray column 128 to the bottom (i.e., nozzles 190A, 190B, 190C, and 190D). The spray nozzles may be distributed at equally-spaced intervals, or at unequally-spaced intervals as depicted in FIG. 15A. Each nozzle 190 can, for example, produce a fan-like spray pattern of approximately 40 degrees (full-width). Additionally, the nozzles 190 can be rotated approximately 10 degrees counter clockwise from the vertical position in order to prevent spray overlap. Alternately, at least one nozzle 190 is configured for spray angle adjustment assembly that allows the user to adjust the spray angle. For example, as depicted in FIG. 15A, the top nozzle 190A is configured for spray angle adjustment in order to adjust the spray angle to a desired elevation. Through adjustment of the top nozzle 190A, the user can ensure sufficient coverage of the top portion of the shower. Thereafter, the remaining nozzles, 190B, 190C, and 190D, can be positioned at angles that provide sufficient coverage of the remaining shower areas. The spray nozzles 190 are fastened to the strip 302A using at least one of a chemical adhesive or mechanical attachment device, in order to achieve the desired angles. In an alternate embodiment, one or more nozzle strip spacers 308 may be utilized to ensure proper spray nozzle alignment with its associated spray column tube spray exit slot 290.

As depicted in FIG. 15A, a tubing manifold 306 is configured to couple to the strip 302A, and provide fluid connections to the one or more spray nozzles 190. For example, the tubing manifold 306 can be located, and the connection points selected, so that when the flow is reversed, all cleaning solution in the tubing is pumped back into the cleaning solution reservoir 130. In an alternate embodiment, a screen filter device 310 can be coupled to the tubing 304 in order to minimize the clogging of the spray nozzles 190. For example, the screen filter device 310 can be positioned in front of the tubing manifold 306, as shown in FIG. 15A. Additionally, for example, the screen filter device 310 can be designed to capture particles larger than one-third the nozzle orifice. Thereafter, these particles may be returned to the cleaning solution reservoir 130 when the remaining cleaning solution in the tubing is pumped backed into the container following each cleaning cycle. Thus, the screen filter device 310 is cleaned after each cleaning process.

Referring now to FIG. 15B, an exploded view of a mechanical assembly for adjusting the spray angle of the top nozzle 190A is presented. An adjustment knob 320 through rotation is configured to adjust the spray angle for top nozzle 190A upward and downward as shown. Adjustment knob 320 is coupled to a shaft 322 configured to couple the spray nozzle 190A to upper nozzle strip 302B via a fastening set of a washer 323 and two threaded nuts 325. The mechanical assembly further comprises a set of washers 324 and a friction plate 326 having a friction member 328 with a spring 330 located therebetween, wherein the spring 330 provides a spring force to press friction member 328 against a front surface 303 of upper nozzle strip 302B. The mechanical assembly is configured to provide sufficient friction between the friction member 328 and the front surface 303 in order to maintain the position of the top nozzle 190A. The top spray nozzle 190A can be mounted on the friction plate 326 using adhesive, for example.

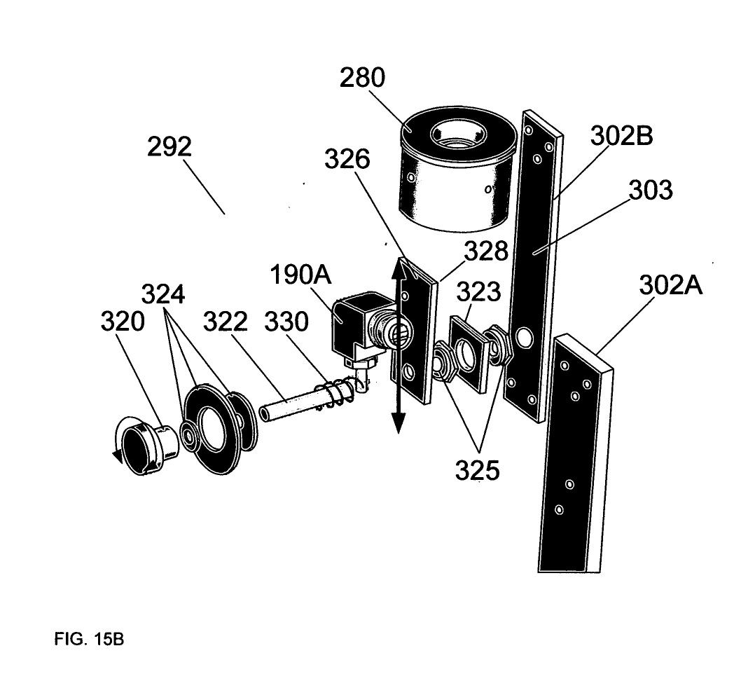

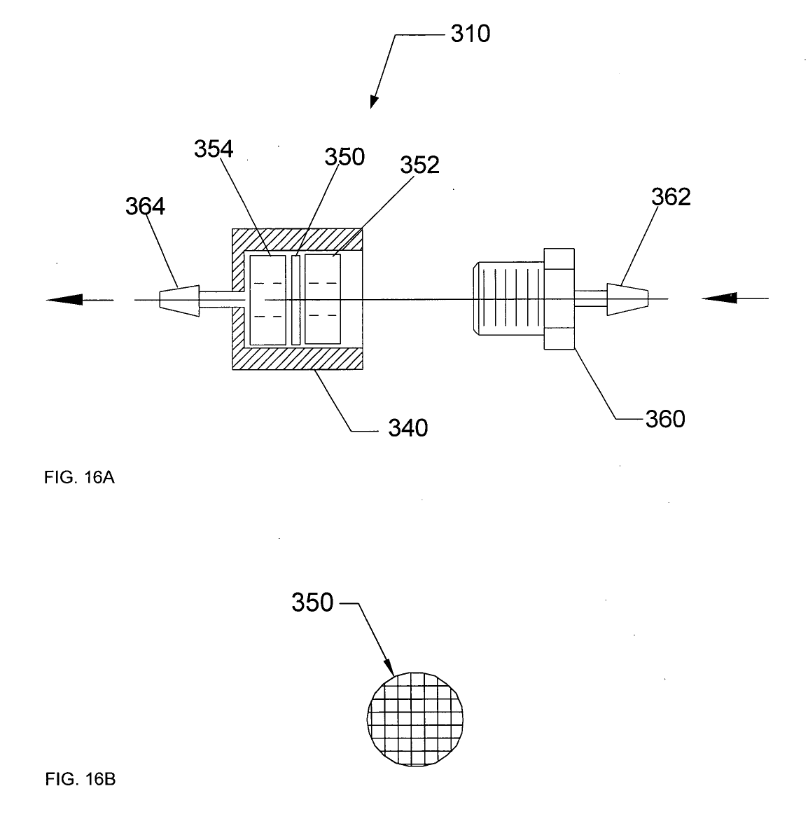

FIGS. 16A and 16B present a cross-sectional view of an exemplary screen filter 310. The screen filter 310 comprises a filter housing 340, a screen 350, a first spacer 352, a second spacer 354, and a filter connector 360 configured to be coupled with the filter housing 340 and compress screen 350 between first spacer 352 and second spacer 354. The filter connector 360 includes a first tubular end 362, and the filter housing 340 includes a second tubular end 364, each tubular end configured to couple with tubing 304 in multi-directional spray column 128. For example, the screen 350 can include model/catalog no. 9230T549 stainless steel mesh commercially available from McMaster-Carr. Additionally, for example, the first and second spacers, 352 and 354, can be fabricated from Teflon, or nylon.

The coating system 101 can be designed to accommodate various shower sizes. Shower size selections can be accomplished by setting shower size selection switches to the positions that corresponds to the desired shower size. The selections switches can, for example, be located on a printed circuit board (PCB) inside enclosure 110. Additionally, the coating system 101 can be designed to accommodate various shower sizes, as well as human body sizes. Human body size selections can be accomplished by setting human body size selection switches to the positions that corresponds to the desired human body size. The selections switches can, for example, be located on a printed circuit board (PCB) inside enclosure 110.

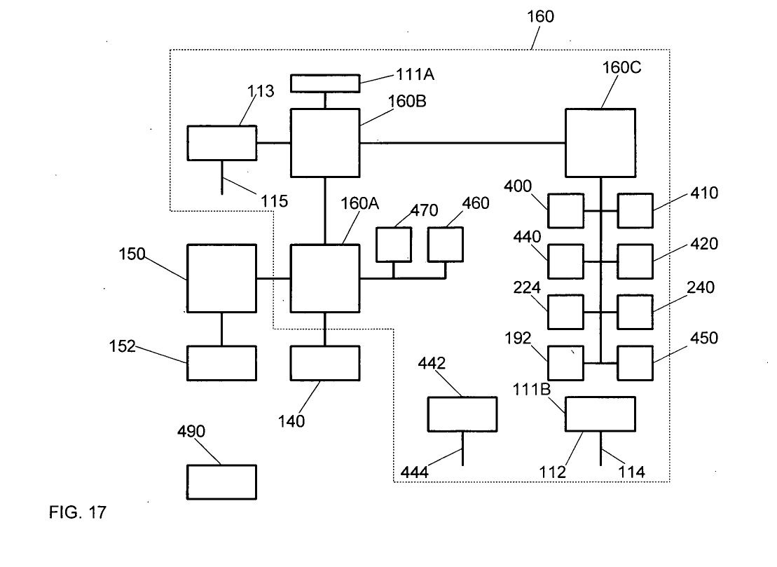

As described earlier, the coating system 101 comprises a control system 160, wherein the control system 160 is configured to perform at least one of distributing power for the coating system 101, and controlling the coating system 101. FIG. 17 presents a schematic block diagram of an exemplary electrical system for the coating system 101.

As shown in FIG. 17, control system 160 comprises a first PCB (printed circuit board) 160A configured to provide a power input connection point to the cleaning system 101, and distribute power and associated control signals. First PCB 160A can include, for example, a single-sided circuit board. First PCB 160A includes components used to control power to the pumping system 140, thereby, for instance, controlling nozzle pressure. The power delivered to the pumping system 140 can be controlled using, for example, pulse width modulation (PWM), and a relay contact that connects the power source 150 directly to the pumping system 140. Power and control signals to other electrical components located inside enclosure 110 can also be routed through the first PCB 160A. Additionally, filters may be utilized to eliminate the effects of noise generated by the pumping system 140. For example, these filters may be located on the first PCB 160A.

Additionally, as shown in FIG. 17, control system 160 further comprises a second PCB 160B configured to provide operational control functions to the coating system 101. The second PCB 160B can include, for example, a double-sided board located inside enclosure 110. The second PCB 160B can also provide a user interface control point for coating system 101. For example, user interface control components (to be discussed below), such as a micro-controller, can be mounted to the second PCB 160B, and these control components can be accessed through openings in the enclosure 110. The micro-controller can, for instance, include a model no. 16F877 controller, commercially available from MicroChip, Inc. The second PCB 160B can, for example, be structurally coupled to the enclosure chassis on PCB standoffs. Enclosure electrical cable 178 electrically connects the second PCB 160B to the first PCB 160A.

Additionally, as shown in FIG. 17, control system 160 further comprises a third PCB 160C configured to function as a hub for all electrical conductors from control components and devices located in the spray column arm 126. The third PCB 160C also includes an electrical connection point for cables, such as electrical cable 178, transmitting electrical signals to and from the second PCB 160B. The following discussion describes several control components that can be provided by the coating system 101.

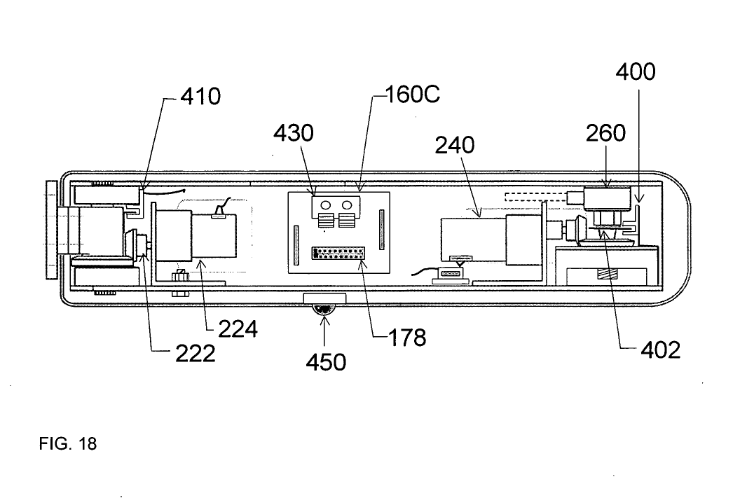

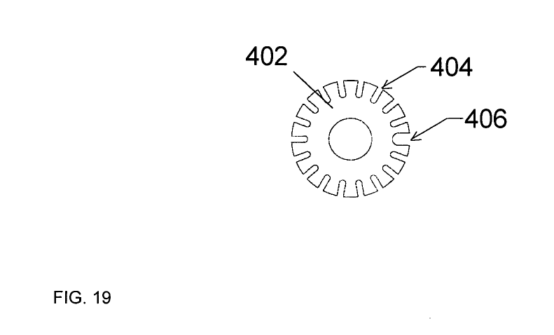

FIGS. 17 and 18 present an illustration of several control functions that can be provided in the spray column arm 126. A spray column switch 400 can be utilized in order to provide inputs to the micro-controller pertaining to the multi-directional spray column speed or position, or both. For example, the spray column switch 400 can include an infrared (IR) optical device, along with a column encoder 402. For instance, the multi-directional spray column speed can be a factor in determining cleaning solution spray coverage or coating solution spray coverage within the shower. Using the rotational speed of the multi-directional spray column as input, the micro-controller can control the speed. The column encoder 402, as shown in FIG. 19 (a layout of a disk with, for example, 18 encoder slots 404 evenly spaced around its peripheral edge creating 10 degree increments) passes and blocks IR light inside the spray column switch 400 as the multi-directional spray column 128 rotates, creating an electrical signature of the column movement.

For example, FIG. 18 shows the location of the column encoder 402 attached to the swivel joint 260. As shown in FIG. 19, all encoder slots 404 are the same size except for one, a home position slot 406, which is larger. The third PCB 160C utilizes a micro-controller to monitor the spray column switch 400 to determine the current multi-directional spray column location signature. After a predetermined number of operations, the micro-controller can compare a known signature for that shower size or human body size to the current signature and adjust the current signature to match the known signature (or target signature). In order to enable the micro-controller to monitor the direction of the nozzles 190, the spray column encoder home position can be aligned with the nozzle openings. For instance, this feature can enable the micro-controller to ensure the multi-directional column spray slots face the wall when the cleaning system 101 is not in operation. It also ensures that the nozzles are pointing in the correct direction at the beginning of the cleaning process or coating process.

The spray column motor 240 can, for example, include a 19 V (DC) gear motor that drives a set of hub gears causing the multi-directional spray column 128 to rotate. The motor speed and associated duration can be managed by the control system 160, and determined by an input signal received from the multi-directional spray column switch 400 and column encoder 402.

An arm home switch 410 can be utilized to determine when the spray column arm 126 is stowed in its home position. For example, the arm home switch 410 can include an optical device that is attached to the top block 200 of the spray column arm 126. A tab attached to the arm mount support 210 disrupts the optical connection inside the arm home switch 410 when the spray column arm 126 reaches its stowed position (or home position). For example, the home position can be represented by the position of fluid dispensing device 125 as shown in FIG. 2B.

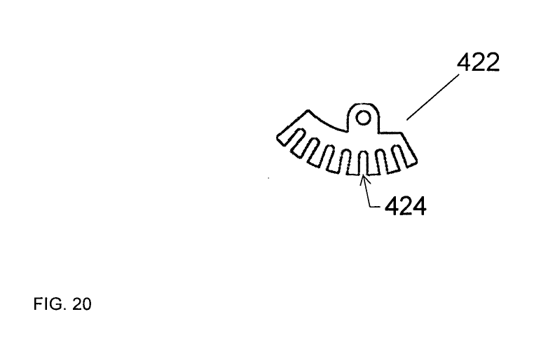

An arm position switch 420 can be utilized to provide data to control system 160 in order to determine the position of the spray column arm 126. For example, the position of the spray column arm 126 can be determined for the azimuthal range extending from 30 to 120 degrees in 10-degree increments. The arm position switch 420 can be an optical switch mounted to the front side of the spray column arm channel, 90 degrees across from the arm home switch 410. As the spray column arm 126 translates, the arm position switch 420 passes through an arm position encoder 422, which is also attached to the arm mount support 210. As the spray column arm 126 translates, the arm position encoder 422 passes (or breaks) the optical signal inside the arm position switch 420 creating an electrical signature as the spray column arm 126 moves. The control system 160 uses this data to determine the position of the spray column arm 126. FIG. 20 presents a representation of the arm position encoder 422 with arm position encoder slots 424.

The arm motor 224 can, for example, include a 19V (DC) gear motor. The power and voltage polarity to the arm motor 224 can be controlled by the control system 160. When a positive voltage is applied to the arm motor 224, the spray column arm 126 opens, and, when a negative voltage is applied to the arm motor 224, the spray column arm 126 closes. The speed at which the spray column arm 126 translates, or the location where the spray column arm 126 stops, is determined by the power applied to the arm motor 224 and the input signals received from the arm home switch 410 and the arm position switch 420.

A shower door status switch 440 can be utilized to determine the status of the shower door. For example, the shower door status switch 440 can comprise a magnetic reed switch, which is attached to the shower door and frame, and monitors the door status, whether it be open or close. When the shower door is open, the shower door status switch 440 is open and when the shower door is closed, the shower door status switch 440 is closed. The magnetic reed switch can enable an electrical signal input into the control system 160, allowing it to determine the shower door status. The electrical signal may be coupled to the control system 160 directly via an electrical cable, or it may, alternatively, be coupled via a wireless RF transmitter 442 having an antenna 444 and a receiver (not shown) coupled to control system 160. For example, the RF transmitter and receiver can include an eight channel transmitter, model no. TXM-900-HP-II-ND and an eight channel receiver, model no. RXM-900-HP-II-ND, respectively, each commercially available from Digikey. A battery, for instance, can be used to provide power for the RF transmitter, and RF receiver. FIG. 2A provides an illustration of the shower door status switch 440 mounted to the shower door, and frame. As shown in FIG. 2A, the shower door status switch 440 can be attached to the edge of the shower glass wall or doorframe. The magnet section attaches to the edge of the door, across from the reed switch section. FIG. 2A also indicates an alternate location (dashed line) for the installation of the shower door status switch 440′. The signal wires can then couple to spring-loaded terminal blocks 430 located on the third PCB 160C (see FIG. 18). An alternate function of the shower door status switch 440 is to monitor the shower door position up to approximately 5 minutes after the cleaning process. During that period, if the door switch status changes from closed to open, the control system 160 generates a warning tone to alert the user to wet surfaces in the shower.

A motion detection system 450 can be utilized to determine shower occupancy. For example, the motion detection system 450 can include a passive-infra-red (PIR) motion detector module. The detection system 450 can be designed specifically for the detection of a human body. Because the infrared signal cannot penetrate the glass, only motion inside of the shower 100 can be detected. As illustrated in FIG. 18, the detection system 450 can be mounted to the bottom middle section of the spray column arm 126. The motion detection module dome protrudes through the bottom of the cover for spray column arm 126. For example, the motion detection system 450 can include an IR motion detector, model no. KC778B (Kit 76), commercially available from Circuit Specialists (220 S. Country Club Drive, #2, Mesa, Ariz. 85210).

The coating system 101 can, for example, provide audio communication as one form of user interface. A mini-speaker 460 located inside the enclosure 110, produces the various tones (to be discussed below). For instance, the control system 160 can generate the tones created by the mini-speaker 460, or vocal expressions created by a voice chip and mini-speaker 460. The voice chip can, for example, include a single chip voice recorder/play-back, series ISD2500, part no. ISD1416S commercially available from Winbon Electronics Corporation America.

The coating system 101 can, for example, provide a cover switch 470 in order to prevent the operation of the coating system 101 should the cover on enclosure 110 not be in place. As shown in FIG. 3, the cover switch 470 can comprise a reed switch, wherein the reed switch section is located within enclosure 110, and a magnet, wherein the magnet is located on the inside of the cover for enclosure 110. When the cover for enclosure 110 is in place, the magnet causes the reed switch contacts to close. Control wires from the cover switch 470 to control system 160 allow it to determine whether the cover for enclosure 110 is in place.

As described above, coating system 101 can provide pressure measurement device 192 configured to measure the pressure of the cleaning solution or coating solution downstream of the pressure side of pumping system 140, and to provide electrical data to control system 160 for regulating power to the pumping system 140, thereby controlling the spray nozzle discharge pressure. As depicted in FIG. 4, the pressure measurement device 192 can be located within the spray column arm 126. Alternatively, the pressure measurement device 192 can, for example, be located in enclosure 110, proximate the outlet (pressure side of pumping system 101).

Additionally, coating system 101 can, for example, provide a watchdog timer configured to cause the coating system 101 to shutdown in the event of a control component failure. For instance, if such an event should occur, the coating system 101 can immediately discontinue the cleaning process and reset. Additionally, if cleaning solution or coating solution is currently being dispensed during the failure, the multi-directional spray column 128 can discontinue rotation; the pumping system 140 can reverse the flow of the cleaning solution or coating solution, and return the cleaning solution or coating solution to the cleaning solution reservoir 130 or coating solution reservoir 131, respectively; and the spray column arm 126 can return to its home position.

Referring again to FIGS. 1 and 2A, the coating system 1 (or coating system 101) can be activated using at least one of a local control interface 111A coupled directly to enclosure 10 (or enclosure 110), or a remote control interface 111B remotely coupled to enclosure 10 (or enclosure 110). For example, the local control interface 111A can be coupled directly to the front surface of enclosure 10 (or enclosure 110). Alternately, for example, the remote control interface 111B can be configured to mount on a wall, such as a bathroom wall, and provide remote access to the control function for operating coating system 1 (or coating system 101) via a radio frequency (RF) wireless system. As shown in FIG. 17, the remote control interface 111B can include a wireless remote control station 112 (having an antenna 114), and a receiver 113 (having an antenna 115) coupled to the second PCB 160B.

When the coating system 1 (101) is activated using control panel 111A (or 111B), the spray column arm 126, if movable, can move from its OFF (or stow) position to its ON position. Once the multi-directional spray column 128 reaches the ON position for cleaning (see FIG. 2B), the multi-directional spray column 128 rotates at a pre-specified rotation rate while cleaning solution is pumped from the cleaning solution reservoir 130 and dispensed within shower 100 via one or more spray nozzles 190 located within the multi-directional spray column 128. Moreover, once the multi-directional spray column 128 reaches the ON position for coating a human body, the multi-directional spray column 128 rotates at a pre-specified rotation rate while coating solution is pumped from the coating solution reservoir 131 and dispensed within shower 100 via one or more spray nozzles 190 located within the multi-directional spray column 128.

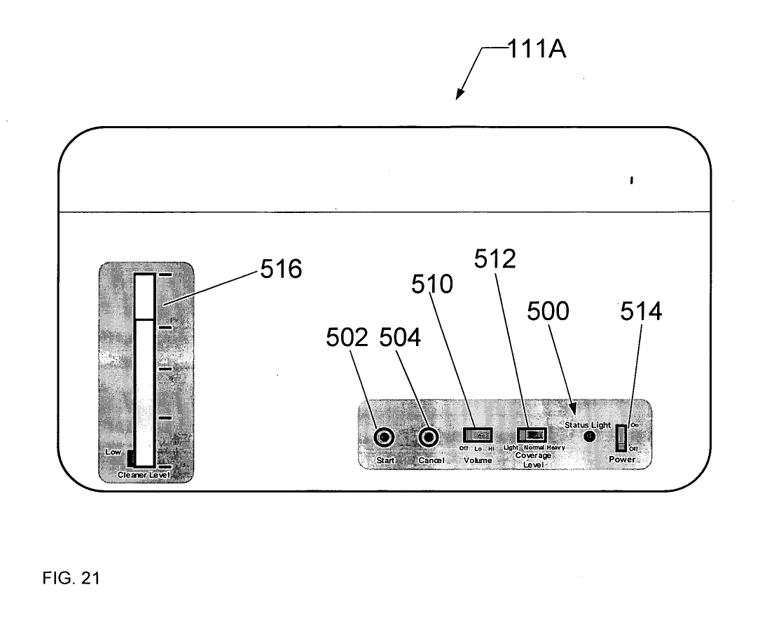

Referring now to FIG. 21, an exemplary local control interface 111A of enclosure 110 is illustrated. The local control interface 111A can provide access to operator controlled functions, as well as provide an opening for an operation status indicator light 500. The operator controlled functions and operation status light 500 are located on the local control interface 111A, e.g., at the bottom right-hand side of the local control interface 111A. The operator-controlled functions are outlined below.

The operation status light 500 can visually communicate the operating status. For example, the operation status light 500 can include a tricolor LED, wherein status colors consist of green, amber, and red while operating states are continuous, high frequency, and low frequency light emission (flashing). Table 1 presents an exemplary relationship between the operational functions and the LED operating modes.

Firstly, the operator-controlled functions can optionally include a start button 502 for starting a cleaning process. For example, the start button 502 may be pressed once in order to initiate a cleaning process. Additionally, for example, the start button 502 is a momentary switch that, when pressed, initiates the cleaning process. For approximately thirty (30) seconds, a high frequency tone pulsates, at approximately one beep per second and the operation status light 500 flashes green at, for instance, the same rate as the tone. This alerts the user to the start of the shower cleaning process. This 30-second-time period is the pre-start alert. After the 30-second alert lapses, the unit starts the cleaning operation. The operation status light 500 discontinues to flash, and emits a continuous green color throughout the duration of the cleaning process. Additionally, for example, the speaker and voice-chip can be programmed to emit an acoustic signal comprising “A cleaning process has been initiated”. Moreover, the operator-controlled functions can optionally include another start button (not shown) for starting a coating process. For example, the start button may be pressed once in order to initiate a coating process

Additionally, the operator-controlled functions can optionally include a cancel button 504. For example, the cancel button 504 may be pressed once in order to terminate a cleaning process or a coating process. Furthermore, for example, the cancel button 504 is a red momentary switch that when pressed, immediately stops the cleaning process or coating process, returning the multi-directional spray column 128 to its stow position. Any cleaning solution or coating solution pumped into the dispensing system 125 can be returned to the cleaning solution reservoir 130 or coating solution reservoir 131, respectively. Thereafter, a continuous high frequency tone may acknowledge the cancellation command, and communicate that the cleaning process has been terminated. At the same time, the operation status light 500 may flash the color red. Additionally, for example, the speaker and voice-chip can be programmed to emit an acoustic signal comprising “A cleaning process has been cancelled”, or “A coating process has been cancelled”.

Additionally, the operator-controlled functions can optionally include a volume switch 510 in order to, for example, select no volume (i.e., off), or a low or high volume. Furthermore, for example, the coating system may emit different sound patterns to communicate various operating status. The volume switch 510 may provide three volume selections (off, low, and high). All safety related tones may remain active even though the tone volume switch is in the off position. For instance, Table 1 presents an exemplary relationship between operating function and tone produced.

Additionally, the operator-controlled functions can optionally include a cleaning coverage level indicator 512 in order to select the amount of cleaning solution to be applied (e.g., light (L), normal (N), or heavy (H)). Furthermore, for example, the purpose of the cleaning coverage level indicator 512 is to select how heavily the cleaning solution can be applied. For instance, the heavier the coating the longer the required spray duration and slower column speed. A slide switch provides for three spray functions.

Additionally, the operator-controlled functions can optionally include a coating coverage level indicator (not shown) in order to select the amount of coating solution to be applied (e.g., light (L), normal (N), or heavy (H)). Furthermore, for example, the purpose of the coating coverage level indictor is to select how heavily the coating solution can be applied. For instance, the heavier the coating the longer the required spray duration and slower column speed. A slide switch provides for three spray functions.

TABLE 1

| Function | | LED | | | Tone | | | |
|---|---|---|---|---|---|---|---|---|
| No. | Operational Function | Color | Rate | Duration | Freq. | Rate | Duration | Comments |
| 1 | Start | — | — | — | — | — | — | Includes door and |
| | Pre-start | Green | Slow | 30 sec. | Med. | 2/sec. | 30 sec. | motion monitoring |
| | Unit Operating | Green | Continuous | Cycle Time | N/A | N/A | N/A | |
| 2 | Cancel | Red | Continuous | 5 sec. | High | Continuous | 5 sec. | The 5 sec. duration |
| | | | | (See | | | | is a minimum. The |
| | | | | Comments) | | | | duration is to be |
| | | | | | | | | the same as it |
| | | | | | | | | takes the unit to |
| | | | | | | | | complete all |
| | | | | | | | | cancel actions. |
| 3 | Safety Violation | — | — | — | — | — | — | LED light lags tone |
| | Motion Detected | Red | Slow | 10 sec. | High | 0.5/sec | 5 Sec. | (tone stops first) |
| | Shower Door Has Been | | | | | | | |
| | Opened | | | | | | | |
| | Shower Door Is Open | | | | | | | |
| 4 | Pre-start Condition Violation | — | — | — | — | — | — | |
| | Invalid Dip Switch Selection | Amber | Continuous | 3 sec. | Med. | 0.5/sec. | 3 sec. | |
| | Spray column arm Not | Red | Continuous | 3 sec. | High | Continuous | 3 sec. | |
| | Stowed | | | | | | | |
| 5 | Low Battery Voltage | Red | Fast | Continuous | Low | 0.5/sec. | 5 sec. | Voltage monitoring is |
| | | | | | | | | required |
| 6 | End Of Operation | Green | Slow | 3 sec. | Low | Continuous | 3 sec. | |
| 7 | Post Operation Monitoring | — | — | — | — | — | — | 1 - Monitor for 5 min. |
| | Area Wet | Amber | Slow | 5 min. | N/A | N/A | N/A | 2 - The unit must |
| | | | | | | | | remain |
| | Shower door Opened | N/A | N/A | N/A | High | 0.5/sec. | Till door | operational to monitor |
| | | | | | | | closes | door |
| 8 | Shower Door Switch Test | | | | | | | The tone is produced |
| | | | | | | | | when the door switch |
| | | | | | | | | is in the open position |
| 9 | Low Pressure (Cleaning | Red | Continuous | 5 sec. | High | Continuous | 5 sec. | |
| | solution reservoir Empty) | | | | | | | |

Additionally, the operator-controlled functions can optionally include a power switch 514 in order to connect and disconnect the power source 150 (i.e., ON/OFF). The power switch 514 may be utilized when servicing the coating system. Furthermore, for example, the power switch 514 connects and disconnects the power source 150 to the coating system, turning it on and off, respectively. This power switch 514 can be in the off position during installation, as well as before removing the front cover once the coating system has been installed. The power switch 514 does not need to be in the off position when the coating system is not in operation. To start the coating system, the start button can be pressed. With the front cover to enclosure 110 removed, the power switch 514 can be pushed down from the off position into the service mode position. This feature enables a service person to operate the coating system, bypassing pre-start and operator safety functions.

Additionally, the local control interface 111A can optionally include a cleaning solution level indicator 516 for monitoring the level of cleaning solution in cleaning solution reservoir 130. For example, the cleaning solution level indicator 516 can include a graduated window. The graduated window can, for instance, be mounted on the left hand side of the local control interface 111A. A red bar adjacent to the bottom of the graduated window can be utilized to alert the user when it is time to replace or refill the cleaning solution reservoir 130. When the level falls to the top of the red bar, there is only enough cleaning solution remaining for a few more cleaning processes. The exact number is dependent on the shower size and associated spray coverage level setting. Alternately, for example, the weight of the cleaning solution reservoir 130 can be monitored in order to determine the amount of cleaning solution remaining in the cleaning solution reservoir. The weight of the cleaning solution reservoir can be monitored, for instance, using a pressure transducer upon which the cleaning solution reservoir 130 rests. The control system 160 can be coupled to the pressure transducer, and configured to ascertain the respective weight. Alternatively, as opposed to a graduated window, an array of LEDs, optionally of different color, can be utilized to indicate the cleaning solution level on the front surface of local control interface 111A. Additionally, the local control interface 111A can optionally include a coating solution level indicator (not shown) for monitoring the level of coating solution in coating solution reservoir 131. For example, the coating solution level indicator can include a graduated window.

The coating system can be designed to accommodate the cleaning of various shower sizes or human body sizes. For example, shower size selection dipswitches 520 can be coupled to control system 160, for instance, they may be coupled to the bottom middle section of the second PCB 160B (see FIG. 3). The shower size selection dipswitches 520 may be used to select the desired shower size program. Additionally, for example, human body size selection dipswitches (not shown) can be coupled to control system 160. The human body size selection dipswitches may be used to select the desired human body size program.

In addition to operator controlled functions, the coating system may provide non-operator controlled functions. For example, the non-operator controlled functions can optionally include a pre-start condition validation in order to determine whether the spray column arm 126 is in a stowed position (i.e., an OFF position). Furthermore, for example, one pre-start condition can require that the spray column arm 126 be in its stowed position before pre-start operational functions can commence.

Additionally, the non-operator controlled functions can optionally include a valid dipswitch selection. For example, each time before the unit begins a cleaning process or coating process, it determines the shower size or human body size to be cleaned or coated by way of the shower size selection dipswitches 520 or human body selection dipswitches. This function communicates to the operator that the current dipswitch positions selected do not correlate to a shower size program or human body size program and are therefore invalid. If this should occur, each time the start button 502 is pressed the operation status light 500 emits a continuous amber light for three seconds while a mid-level frequency tone pulsing at a fast rate is generated. The coating system may not operate until a valid shower size program or valid human body size program is selected. Additionally, for example, the speaker and voice-chip can be programmed to emit an acoustic signal comprising “An improper shower size program has been selected”, or “An improper human body size program has been selected”.

Additionally, the non-operator controlled functions can optionally include a safety violation shutdown for use during a cleaning process. For example, a safety violation shutdown occurs when an operational safety requirement is violated. Exemplary violations may include: a “Shower Occupied” violation, or a “Shower Door Open” violation. In the former case, the shower cannot be occupied when the coating system is in operation. Before the spray column arm 126 is deployed, the motion detection system 450 coupled to the spray column arm 126 monitors the shower area for movement. If motion is detected, the coating system can wait for a predetermined period of time then monitor the area again for motion. If motion is detected for a second time, the coating system can immediately reset, and not deploy the spray column arm 126. In the latter case, the shower door must remain closed throughout the entire cleaning process. Should the door open, the coating system immediately discontinues the cleaning process. If the unit is administering a cleaning process, the multi-directional spray column 128 can discontinue rotation; the pumping system 140 can reverse the flow of the cleaning solution, and return the cleaning solution to the cleaning solution reservoir 130; and the spray column arm 126 can return to its home position. If not already stowed, the spray column arm 126 can be manually moved back to the stow position in order for the coating system to operate. In order to communicate that a safety shutdown has occurred, the operation status light 500 can emit, for instance, a continuous red color for ten seconds as a status tone oscillating at a rate of 0.5 cycles/sec for duration of ten seconds is generated (see Table 1). Additionally, for example, the speaker and voice-chip can be programmed to emit an acoustic signal comprising “The door is ajar”, or “Please exit the shower”.

Additionally, the non-operator controlled functions can optionally include a shower door open delay. For example, if the shower door is left open after the start button 502 has been pressed, the coating system can delay the start of the cleaning process, for up to a pre-specified period of time such as two minutes. During this period, the coating system emits, for instance, a high frequency fast pulsating tone while the operation status light 502 flashes the color amber to communicate the delay (see Table 1). If the shower door remains open after two minutes, a safety violation has occurred. The coating system may perform the safety violation functional sequence described above.

Additionally, the non-operator controlled functions can optionally include an indication of low battery voltage. For example, when the battery voltage drops to a predetermined value, the operation status light 500 starts to flash the color amber. At that point, the coating system discontinues the cleaning process or coating process; the spray column arm returns to the stow position; and the coating system resets. Any cleaning solution or coating solution pumped into the dispensing system 125 is pumped back into the cleaning solution reservoir 130 or coating solution reservoir 131, respectively. At the same time, the unit emits a continuous low frequency tone for five seconds to alert the user that the battery voltage is too low for continued operation. The operation status light 500 will continue to flash until the unit is turned off, or the battery voltage becomes too low for the coating system to allow the status light to continue to operation (see Table 1).

Additionally, the non-operator controlled functions can optionally include an indication of the end of operation. For example, in order to communicate the completion of each cleaning process or coating process, the operation status light 500 flashes the color green at a high rate for three seconds while at the same time, the low frequency continuous tone is generated for three seconds (see Table 1). Additionally, for example, the speaker and voice-chip can be programmed to emit an acoustic signal comprising “The cleaning process has been completed”, or “The coating process has been completed”.

Additionally, the non-operator controlled functions can optionally include post-operation monitoring. For example, the post operation monitoring function can alert a user attempting to enter the shower, within five minutes after a cleaning process has been administered, that the shower surfaces may be wet. During this period, the operation status light 500 slowly flashes amber. If the shower door opens, a high frequency tone is emitted until the door is closed (see Table 1). Additionally, for example, the speaker and voice-chip can be programmed to emit an acoustic signal comprising “The shower surfaces are wet”.

Additionally, the non-operator controlled functions can optionally include a shower door switch installation test. For example, this function can be used to assist with installation by helping to ensure that the shower door magnetic reed switch parts are installed within a functional proximity of one another. It can be selected by way of the shower size selection dipswitches 520, which are used to select shower size programs. When this function is active, a mid-frequency tone pulsating at a slow rate is emitted signaling that the shower door switch parts are not within a functional proximity (see Table 1).

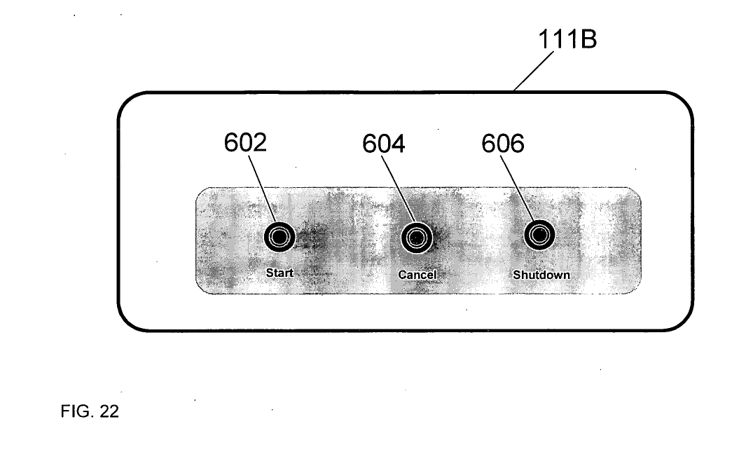

Referring now to FIG. 22, an exemplary remote control interface 111B of enclosure 110 is illustrated. The remote control interface 111B can provide access to operator controlled functions. The remote control interface 111B can optionally include a remote start button 602 for starting a cleaning process. For example, the remote start button 602 may be pressed once in order to initiate a cleaning process. Additionally, for example, the remote start button 602 is a momentary switch that, when pressed, initiates the cleaning process. For approximately thirty (30) seconds, a high frequency tone pulsates, at approximately one beep per second and the operation status light 500 flashes green at, for instance, the same rate as the tone. This alerts the user to the start of the shower cleaning process. This 30-second-time period is the pre-start alert. After the 30-second alert lapses, the unit starts the cleaning operation. The status light discontinues to flash, and emits a continuous green color throughout the duration of the cleaning process. Additionally, the remote control interface 111B can optionally include a remote start button (not shown) for starting a coating process. For example, the remote start button may be pressed once in order to initiate a coating process.

The remote control interface 111B can optionally include a remote cancel button 604. For example, the remote cancel button 604 may be pressed once in order to terminate a cleaning process or coating process. Furthermore, for example, the remote cancel button 604 is a red momentary switch that when pressed, immediately stops the cleaning process or coating process, returning the multi-directional spray column 128 to its stow position. Any cleaning solution or coating solution pumped into the dispensing system 125 can be returned to the cleaning solution reservoir 130 or coating solution reservoir 131, respectively. Thereafter, a continuous high frequency tone may acknowledge the cancellation command, and communicate that the cleaning process or coating process has been terminated. At the same time, the operation status light 500 may flash the color red.

The remote control interface 111B can optionally include a remote shutdown button 606. For example, the remote shutdown button 606 may be pressed once to completely disable the coating system.

The remote control interface 111B includes a housing that can, for example, be fabricated from ABS plastic. As shown in FIG. 22, a silk-screen cover displays the remote controller operational function. The housing can be configured to be mounted to a wall by way of fasteners, such as screws or anchor bolts. The RF transmitter can, for example, operate at a frequency of 900 MHz. Furthermore, the transmitter may be powered by a battery. The receiver circuit board can, for example, be mounted to the second PCB 160B located inside the enclosure 110. The receiver can detect a signal from the transmitter. For example, the RF transmitter and receiver can include an eight channel transmitter, model no. TXM-900-HP-II-ND and an eight channel receiver, model no. RXM-900-HP-II-ND, respectively, each commercially available from Digikey. A battery can be utilized to provide power for the RF transmitter and the RF receiver. As shown in FIG. 17, an antenna inside the enclosure 110 receives the signal from the transmitter. The signal is then decoded and the appropriate control function is executed by the control circuitry. The transmitter and receiver can be both FCC licensed and are pre-manufactured devices provided by a qualified electronics manufacturer that meets all U.S. government requirements.

As described above, the coating system can be programmed to execute a cleaning recipe or coating recipe and, for example, to apply an appropriate amount of cleaning solution for a given size shower or an appropriate amount of coating solution for a given human body size. The programming also enables the coating system to apply a consistent amount of cleaning solution to all surfaces regardless of shower size or location of the spray nozzles 190 from the spray surface. The shower size selection dipswitches 520 on the second PCB 160B can be used to select the nozzle spray program for a specific shower size. Each nozzle spray program contains a table that lists spray distance, multi-directional spray column speed, and pump pressure data in 10-degree increments (same as the spray column encoder) along the shower perimeter. The spray column switch with its encoder provides column position data to the control system 160. When administering a cleaning process or coating process, the control system 160 uses data from both the nozzle spray program table and the spray column switch to regulate multi-directional spray column speed and pump pressure while the multi-directional spray column 128 rotates. For example, the greater the distance between the spray nozzles 190 from the spray surface, either the multi-directional spray column 128 can rotate slower, or the nozzle pressure required can be greater, or both. If the multi-directional spray column 128 rotates too fast, centrifugal force can cause the nozzle spray to swirl, preventing it from reaching the intended shower surfaces.

Additionally, for example, the control system 160 can further comprise a wireless connection with a home personal computer 490, and can be configured to provide the home personal computer 490 with at least one of a status of the cleaning solution level in the cleaning solution reservoir, a status of the coating solution in the coating solution reservoir, a status of the battery in the remote control interface 111B, and a status of the battery in the wireless door switch. A channel in the RF transmitter coupled to the remote control interface 111B and the RF receiver coupled to the control system 160 can be dedicated to providing battery status information to control system 160. Likewise, a channel in the RF transmitter coupled to the wireless door switch and the RF receiver coupled to the control system 160 can be dedicated to providing battery status information to control system 160. The home personal computer 490 can include, for example, a DELL PRECISION WORKSTATION 530™, available from Dell Corporation, Austin, Tex. Additionally, the home personal computer 490 can be configured to include the receiving end of the wireless connection, such as a model 1240 TDS Stargate, Interactive Intelligent Home Control System commercially available from JDS Uniphase, Inc. The wireless connection can permit providing status information to the home personal computer 490 for modifying at least one software program on the home personal computer 490 in order to alert a user to such status information.

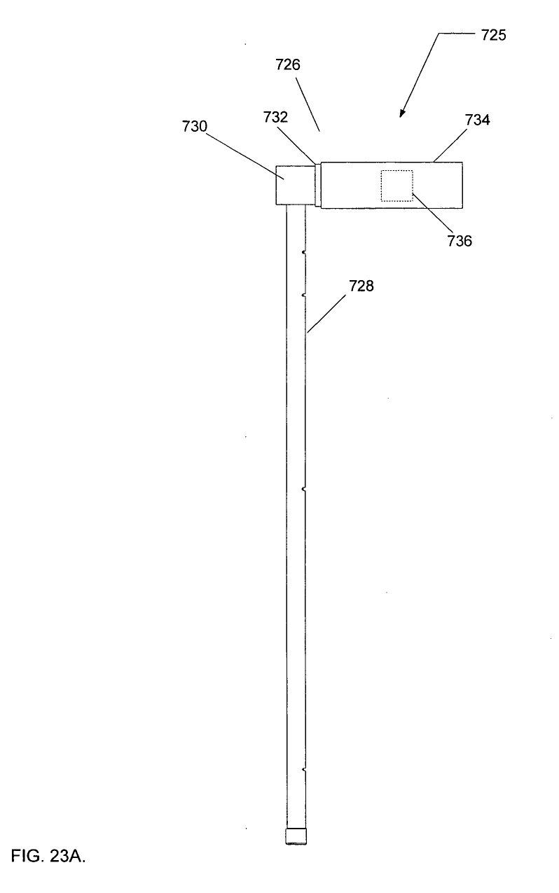

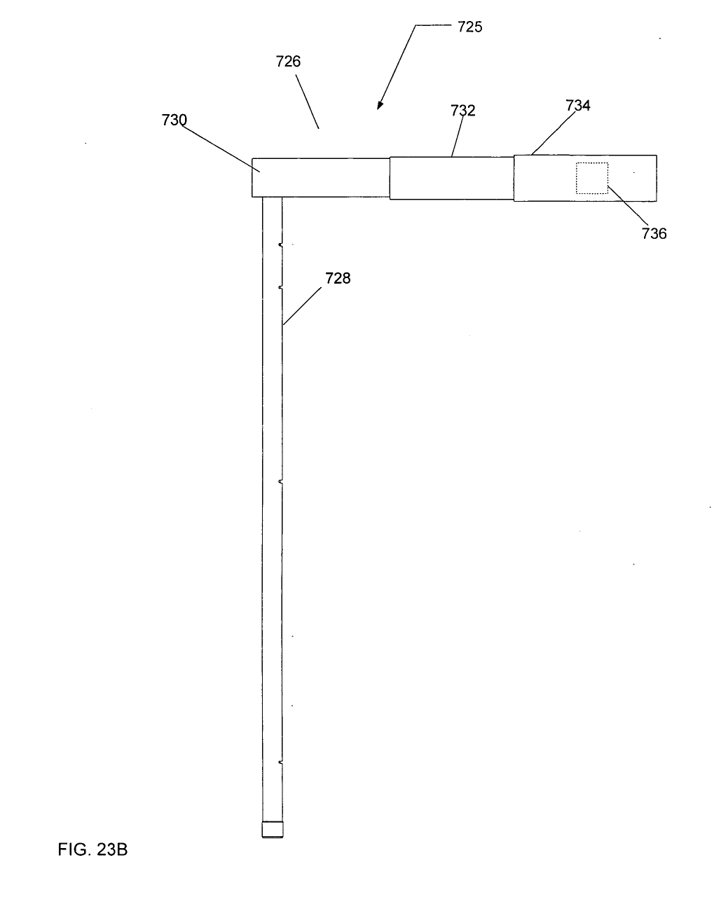

FIGS. 23A and 23A present a fluid dispensing device 725 for a coating system according to yet another embodiment. The fluid dispensing device 725 comprises a telescoping spray column arm 726 and a multi-directional spray column 728 coupled to the telescoping spray column arm 726. As depicted in FIGS. 23A and 23B, the telescoping spray column arm 726 can comprise a first column element 730, a second column element 732, and a third column element 734. For example, FIG. 23A illustrates the telescoping spray column arm 726 in a retracted position, and FIG. 23B illustrates the telescoping spray column arm 726 in an extended position. Although FIGS. 23A and 23B depict the telescoping spray column arm 726 with three column elements, the telescoping spray column 726 can have two, or more than three column elements. Also shown in FIGS. 23A and 23B, a linear actuating system 736 can be housed in the telescoping spray column arm 726 in order to extend and retract the telescoping spray column arm 726. An exemplary linear actuating system 736 can include one or more linear actuators, such as model MAGFORCE linear actuator commercially available from SKF Magnetic Actuators.

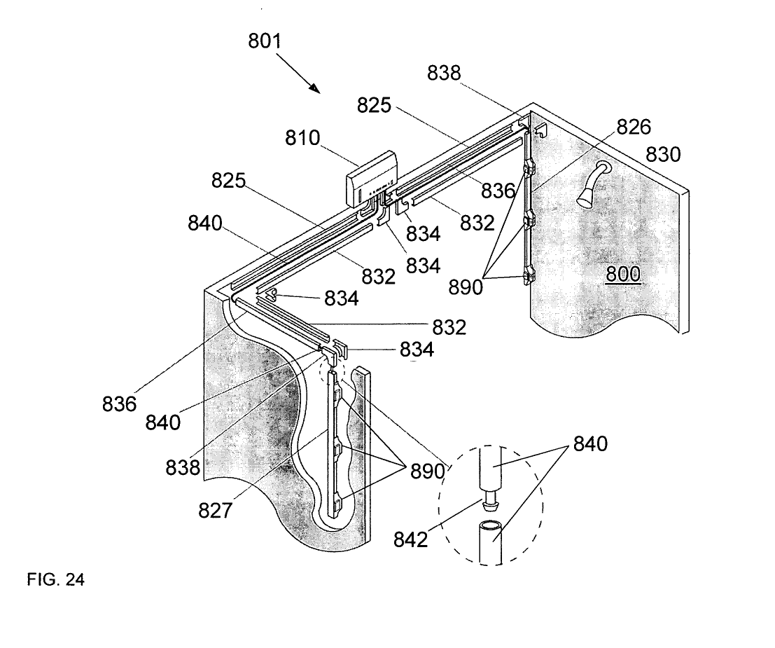

Referring now to FIG. 24, a coating system 801 for a shower 800 is presented for yet another embodiment. A fluid dispensing device 825 is fluidly coupled to an enclosure 810, wherein the fluid dispensing device 825 comprises one or more spray arms, such as a first spray arm 826 and a second spray arm 827. Each spray arm 826, 827 includes tubing 840 which is coupled to shower 800 via inner mounting panels 832 and outer mounting panels 836 having inner and outer mounting elbows 834 and 838, respectively, for 90 degree bends. Each spray arm 826, 827 includes one or more spray nozzles 890 fluidly coupled to tubing 840. Pieces of tubing 840 can be coupled to one another via tubing connectors 842.

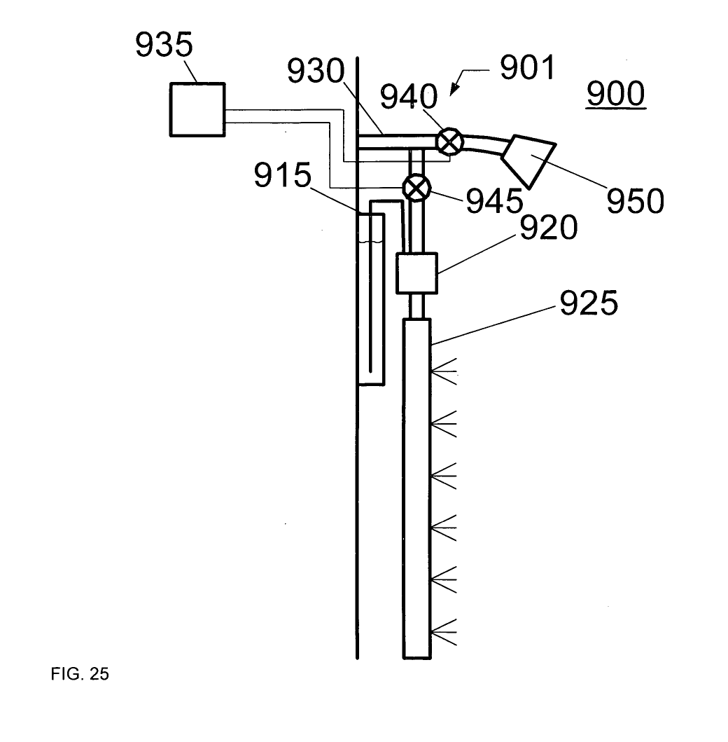

Referring now to FIG. 25, a coating system 901 for a shower 900 is presented for yet another embodiment. The coating system 901 comprises a cleaning solution reservoir 915 (or coating solution reservoir, or both) configured to hold a cleaning solution (or coating solution, for example), a fluid dispensing device 925 configured to dispense the cleaning solution within the shower 900 for the purpose of cleaning the shower, a pumping system 920, such as a Venturi system, coupled to the cleaning solution reservoir 915, and configured to supply the fluid dispensing device 925 with cleaning solution under pressure from the cleaning solution reservoir 915. The cleaning system 901 further comprises a power source 930, such as the mechanical energy stored in a city water line and the associated plumbing, coupled to the pumping system 920, and configured to provide the pumping system 920 with high pressure water (or mechanical energy) for pumping the cleaning solution. The fluid dispensing device 925 can be stationary, or it can be non-stationary. Although the fluid dispensing device 925 depicted in FIG. 25 is shown to be configured to dispense a cleaning solution from the cleaning solution reservoir 915, the fluid dispensing device 925 can also be configured to dispense a coating solution from a coating solution reservoir (not shown) in much the same manner.

Coating system 901 is coupled to a shower faucet 950 configured to dispense water in the shower 900. A first valve 940 can turn on or off the flow of water into the cleaning system 901, and a second valve 945 can turn on or off the flow of water through shower faucet 950. Additionally, a control system 935 coupled to the first valve 940 and the second valve 945 is configured to open and close the first and second valves, 940 and 945, respectively. For example, during use of the shower faucet, the first valve 940 is closed, and the second valve 945 is opened. During use of the coating system 901, the first valve 940 is opened, and the second valve 945 is closed. When using the coating system 901, the first valve 940 is opened, and the water under high pressure passes into the coating system 901 through the pumping system 920, or Venturi system, and thereby drawing cleaning solution from the bottom of the cleaning solution reservoir 915 and dispensing the cleaning solution in the shower 900 through the fluid dispensing device 925.

According to another embodiment, a method of coating a human body in a coating chamber is described. The method comprises providing a human skin coating composition, introducing the human skin coating composition to the coating chamber; directing the human skin coating composition onto at least a portion of the human body; removing the human body from the coating chamber, and cleaning the coating chamber in order to remove the human skin coating composition from the coating chamber.

For instance, a method of coating a human body in a coating system is described. The method comprises: initiating a coating process for coating the human body with a coating solution in a coating chamber configured to receive the human body using a coating system, wherein the coating system comprises a coating solution reservoir configured to store the coating solution, a fluid dispensing device configured for dispensing the coating solution in the coating chamber, and a pumping system coupled to the coating solution reservoir and configured to supply the coating solution from the coating solution reservoir to the fluid dispensing device; dispensing the coating solution on at least a portion of the human body in the coating chamber; terminating the coating process; initiating a cleaning process configured to be performed by the coating system, the coating system further comprises a cleaning solution reservoir configured to store a cleaning solution, wherein the pumping system is further coupled to the cleaning solution reservoir and configured to supply the cleaning solution to the fluid dispensing device; dispensing the cleaning solution in the coating chamber to remove the coating solution from the coating chamber; and terminating the cleaning process.

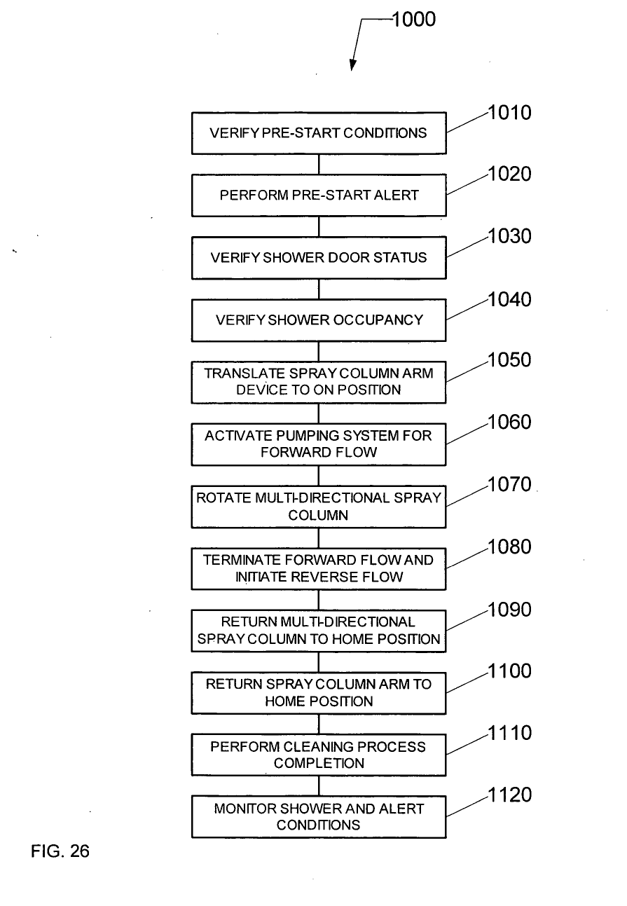

Additionally, for instance, FIG. 26 presents a method of operating a coating system in order to clean a shower following the dispensing of a coating solution according to an embodiment of the present invention. The coating system can include, for example, the coating system 1 described in FIG. 1, or coating system 101 described in FIGS. 2 through 23, or coating system 801 described in FIG. 24, or coating system 901 described in FIG. 25. The method is presented as a flowchart 1000 beginning in 1010 with verifying pre-start conditions. For example, one pre-start condition can require that the spray column arm 126, if movable, be in its stowed position (i.e., an OFF position) before pre-start operational functions can commence. Additionally, for example, the pre-start condition validation can include determining whether the shower size selection dipswitches 520 are set to a proper selection. Additionally, for example, the pre-start condition validation can include determining whether a first valve (such as coating solution valve 70 shown in FIG. 1) is closed to prevent the flow of coating solution from the coating solution reservoir 65 (see FIG. 1), and whether a second valve (such as cleaning solution valve 72 as shown in FIG. 1) is open to permit the flow of cleaning solution from the cleaning solution reservoir 15 (see FIG. 1). Additionally, for example, the pre-start condition validation can include determining whether a third valve (such as purge valve 74 shown in FIG. 1) is closed to prevent the purging of the pumping system and fluid dispensing device.

In 1020, a pre-start alert is performed. The user can be alerted to the initiation of a cleaning process via an audible tone from speaker 460.

In 1030, a shower status is performed during which a determination of whether or not the shower door is open or closed is made. For example, if the shower door is left open after the start button 502 has been pressed, the coating system can delay the start of the cleaning process, for up to two minutes. During this period, the cleaning system emits, for instance, a high frequency fast pulsating tone while the operation status light 502 flashes the color amber to communicate the delay (see Table 1). If the shower door remains open after two minutes, a safety violation has occurred.

In 1040, a shower occupancy verification is performed during which a determination is made whether a human is present within the shower. For example, before the spray column arm is deployed, the motion detection system 450 coupled to the spray column arm monitors the shower area for movement. If motion is detected, the coating system can wait for a predetermined period of time then monitor the area again for motion. If motion is detected for a second time, the cleaning system can immediately reset, and not deploy the spray column arm.

In 1050, the fluid dispensing device is activated. For example, the spray column arm 126 can translate, or rotate, or both from its home (OFF) position to its ON position. For example, control system 160 can set a position for the spray column arm 126. For embodiments where the fluid dispensing device is stationary, it may not be necessary to perform this step.

In 1060, the pumping system 140 is activated for forward flow of the cleaning solution through the coating system. For example, control system 160 can set an injection pressure for the cleaning system.

In 1070, the cleaning solution is dispensed from the fluid dispensing device. For example, the multi-directional spray column 128 can rotate, and dispense cleaning solution within the shower. Additionally, for example, control system 160 can set at least one of the position, the rate of rotation, and the variation in the rate of rotation of the multi-directional spray column 128.

In 1080, the dispensing of cleaning solution into the shower is terminated. For example, the electrical polarity to the pumping system 140 can be reversed in order to reverse the pump action and reverse the flow of cleaning solution through the cleaning system. During a period of reverse flow, the cleaning solution can be returned to the cleaning solution reservoir 130.

In 1090 and 1100, the fluid dispensing device is returned to its home (or OFF) position. For example, the multi-directional spray column 128 can be returned to its home position, and the spray column arm 126 can be returned to its home position. For embodiments where the fluid dispensing device is stationary, it may not be necessary to perform this step.

In 1110, a completion of the cleaning process is performed during which the user is alerted to its completion. For example, in order to communicate the completion of each cleaning process, the operation status light 500 flashes the color green at a high rate for three seconds while at the same time, the low frequency continuous tone is generated for three seconds (see Table 1).

In 1120, the shower is monitored, and the user is informed of the conditions of the shower. For example, the post operation monitoring function can alert a user attempting to enter the shower, within five minutes after a cleaning process has been administered, that the shower surfaces may be wet. During this period, the operation status light 500 slowly flashes amber. If the shower door opens, a high frequency tone is emitted until the door is closed (see Table 1).

The invention has been described in the context of a shower; however, it may be employed in other enclosures useful for attending to personal hygiene, such as saunas, etc.

Although only certain exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention.

What is claimed is:

1. A coating system comprising:
a coating chamber configured to receive a human body;
a coating solution reservoir configured to hold a coating solution;
a cleaning solution reservoir configured to hold a cleaning solution;
a fluid dispensing device configured to automatically dispense said coating solution within said coating chamber on said human body, and automatically dispense said cleaning solution within said coating chamber;
a pumping system coupled to said cleaning solution reservoir and configured to supply said cleaning solution from said cleaning solution reservoir to said fluid dispensing device, and coupled to said coating solution reservoir and configured to supply coating solution from said coating solution reservoir to said fluid dispensing device; and
a power source coupled to said pumping system, and configured to provide said pumping system with power.

2. The coating system of claim 1, wherein said coating solution comprises a self-tanning composition, a muscle relaxant composition, a sunburn treatment composition, an insect repellant composition, a skin toner composition, an exfoliant composition, an anti-microbial composition, a skin nutriment composition, a skin vitamin composition, a skin wrinkle treatment composition, a skin decontamination composition, a medicated skin treatment composition, a massaging aid composition, a cosmetic composition, a moisturizing composition, or a fragrant composition, or any combination thereof.

3. The coating system of claim 1, further comprising:
a control system coupled to said pumping system, and configured to operate said pumping system according to a coating recipe and a cleaning recipe, wherein said power source is further coupled to said control system and configured to provide said control system with power for performing said coating recipe and said cleaning recipe.

4. The coating system of claim 3, wherein said control system is further coupled to said fluid dispensing device, and is configured to operate said fluid dispensing device according to said coating recipe and said cleaning recipe.

5. The coating system of claim 4, further comprising:
means for measuring a position of said fluid dispensing device coupled to said control system.

6. The coating system of claim 5, wherein said coating recipe includes a target position for said fluid dispensing device, and said control system is configured to control said fluid dispensing device in order to minimize a difference between said measured position of said fluid dispensing device and said target position.

7. The coating system of claim 4, further comprising:
means for measuring a rate of translation of said fluid dispensing device coupled to said control system.

8. The coating system of claim 7, wherein said coating recipe includes a target rate of translation for said fluid dispensing device, and said control system is configured to control said fluid dispensing device in order to minimize a difference between said measured rate of translation of said fluid dispensing device and said target rate of translation.

9. The coating system of claim 4, further comprising:
means for measuring a rate of rotation of said fluid dispensing device coupled to said control system.

10. The coating system of claim 9, wherein said coating recipe includes a target rate of rotation for said fluid dispensing device, and said control system is configured to control said fluid dispensing device in order to minimize a difference between said measured rate of rotation of said fluid dispensing device and said target rate of rotation.

11. The coating system of claim 3, further comprising:
a detection system coupled to said control system, and configured to perform at least one of determining whether a person is within said shower, determining whether or not a door coupled to said shower is open or closed, determining a status of said fluid dispensing device, determining a status of said pumping system, and determining a status of said power source.

12. The coating system of claim 1, wherein said fluid dispensing device comprises a spray column arm, and a multi-directional spray column coupled to said spray column arm, said spray column arm configured to translate said multi-directional spray column in said coating chamber and said multi-directional spray column configured to rotate about a longitudinal axis and dispense at least one of said coating solution, said cleaning solution, and a rinsing solution.

13. The coating system of claim 12, wherein said multi-directional spray column comprises one or more spray nozzles configured to inject at least one of said coating solution, said cleaning solution, and said rinsing solution into said shower.

14. The coating system of claim 13, wherein said one or more spray nozzles are unequally spaced along said multi-directional spray column.

15. The coating system of claim 13, wherein said one or more spray nozzles are each angled differently with respect to said longitudinal axis.

16. The coating system of claim 12, wherein said multi-directional spray column comprises a first set of nozzles configured to dispense said coating solution, and a second set of nozzles configured to dispense said cleaning solution.

17. The coating system of claim 16, wherein said first set of nozzles are configured to atomize said coating solution.

18. The coating system of claim 12, wherein said spray column arm comprises a telescoping spray column arm.

19. The coating system of claim 1, wherein said fluid dispensing device comprises one or more spray nozzles configured to inject at least one of said coating solution, said cleaning solution, and said rinsing solution into said shower.

20. The coating system of claim 19, wherein said fluid dispensing device comprises a first set of nozzles configured to dispense said coating solution, and a second set of nozzles configured to dispense said cleaning solution.

21. The coating system of claim 20, wherein said first set of nozzles are configured to atomize said coating solution.

22. The coating system of claim 1, wherein said fluid dispensing device is at least one of stationary, and non-stationary.

23. The coating system of claim 1, wherein said pumping system is configured to reverse the flow of said cleaning solution, and return said cleaning solution in said fluid dispensing device to said cleaning solution reservoir.

24. The coating system of claim 3, further comprising:
a control interface coupled to said control system and configured to provide a user access to operating said coating system, wherein said control interface comprises at least one of a local control interface physically coupled to said control system and a remote control interface remotely coupled to said control system.

25. The coating system of claim 24, wherein said remote control interface comprises a radio frequency (RF) transmitter, a RF receiver, and a battery configured to provide power to said RF transmitter and said RF receiver.

26. A method of coating a human body in a coating chamber comprising:
providing a human skin coating composition;
introducing said human skin coating composition to said coating chamber;
directing said human skin coating composition onto at least a portion of said human body;
removing said human body from said coating chamber; and
cleaning said coating chamber in order to remove said human skin coating composition from said coating chamber.

27. The method of claim 26, wherein said providing said human skin coating composition includes providing at least one of a self-tanning composition, a muscle relaxant composition, a sunburn treatment composition, an insect repellant composition, a skin toner composition, an exfoliant composition, an anti-microbial composition, a skin nutriment composition, a skin vitamin composition, a skin wrinkle treatment composition, a skin decontamination composition, a medicated skin treatment composition, or a massaging aid composition, or a moisturizing composition, or a fragrant composition, or any combination thereof.

28. A method of coating a human body in a coating system comprising: initiating a coating process for coating said human body with a coating solution in a coating chamber configured to receive said human body using a coating system, wherein said coating system comprises a coating solution reservoir configured to store said coating solution, a fluid dispensing device configured for dispensing said coating solution in said coating chamber, and a pumping system coupled to said coating solution reservoir and configured to supply said coating solution from said coating solution reservoir to said fluid dispensing device;
dispensing said coating solution on at least a portion of said human body in said coating chamber;
terminating said coating process;
initiating a cleaning process configured to be performed by said coating system, said coating system further comprises a cleaning solution reservoir configured to store a cleaning solution, wherein said pumping system is further coupled to said cleaning solution reservoir and configured to supply said cleaning solution to said fluid dispensing device;
dispensing said cleaning solution in said coating chamber to remove said coating solution from said coating chamber; and
terminating said cleaning process.

29. The method of claim 28, wherein said dispensing said coating composition includes dispensing at least one of a self-tanning composition, a muscle relaxant composition, a sunburn treatment composition, an insect repellant composition, a skin toner composition, an exfoliant composition, an anti-microbial composition, a skin nutriment composition, a skin vitamin composition, a skin wrinkle treatment composition, a skin decontamination composition, a medicated skin treatment composition, a cosmetic composition, or a massaging aid composition, or any combination thereof.
